(19) United States
(12) Patent Application Publication
(10) Pub. No.: US 2023/0401572 A1
(43) Pub. Date: Dec. 14, 2023

(54) PAYMENT SETTLEMENT VIA CRYPTOCURRENCY EXCHANGE FOR FIAT CURRENCY

(71) Applicant: The Toronto-Dominion Bank, Toronto (CA)

(72) Inventors: Miguel Navarro, Ewing, NJ (US); Levi Sutter, Westampton, NJ (US)

(73) Assignee: The Toronto-Dominion Bank, Toronto (CA)

(21) Appl. No.: 17/838,615

(22) Filed: Jun. 13, 2022

(51) Int. Cl. G06Q 20/38; G06Q 20/36

(52) U.S. Cl. CPC G06Q 20/381; G06Q 20/3678; G06Q 20/389

(57) ABSTRACT

An example operation may include one or more of receiving a payment amount and an identifier of a recipient account from a digital wallet application of a user, the digital wallet application containing a payment card account and a cryptocurrency account, determining to perform a buy-now pay-later (BNPL) transaction for the payment amount based on current holdings in the payment card account and current holdings in the cryptocurrency account; transmitting, via a crypto-bridge application programming interface (API), fiat currency from the payment card account to a crypto exchange, receiving, via the crypt-bridge API, an amount of the cryptocurrency based on the payment amount and store the amount of cryptocurrency in the digital wallet application; generating an entry comprising a future date, the identifier of the recipient account, and a return value to retrieve from the crypto exchange at the future date, and storing the entry in the queue.

### BACKGROUND

The recent introduction of cryptocurrency provides users with additional payment options when purchasing goods and services in place of a more traditional form of payment such as fiat currency (e.g., credit card, debit card, bank account, etc.) Cryptocurrency is not usually backed by a form of collateral and therefore tends to have more volatility than traditional fiat currencies, which a central bank usually backs. As a result, the value of the cryptocurrency is often moving up and down concerning fiat currency over time. However, knowing when to use cryptocurrency and when to use fiat currency is not usually apparent to a user/owner of the cryptocurrency. Furthermore, in many situations, using cryptocurrency is not available. As a result, a user is restricted to using a fiat-based payment method such as a checking account, credit card, or debit card, even though the user has cryptocurrency available.

### SUMMARY

One example embodiment provides an apparatus that may include a memory device comprising a queue, and a processor configured to receive a payment amount and an identifier of a recipient account from a digital wallet application of a user, predict, via a machine learning model, a future value of a cryptocurrency of the cryptocurrency account based on historical values of the cryptocurrency over time, determine to perform a buy-now-pay-later (BNPL) transaction for the payment amount based on the predicted future value of a cryptocurrency stored within the digital wallet application of the user, transmit, via a crypto-bridge application programming interface (API), fiat currency from a fiat account of the user to a crypto exchange, and receive, via the crypt-bridge API, an amount of the cryptocurrency based on the payment amount and store the amount of cryptocurrency in the blockchain wallet, generate an entry comprising a future date, the identifier of the recipient account, and a return value to retrieve from the crypto exchange at the future date, and store the entry in the queue.

Another example embodiment provides a method that includes one or more of receiving a payment amount and an identifier of a recipient account from a digital wallet application of a user, predicting, via a machine learning model, a future value of a cryptocurrency of the cryptocurrency account based on historical values of the cryptocurrency over time, determining to perform a buy-now-pay-later (BNPL) transaction for the payment amount based on the predicted future value of a cryptocurrency stored within the digital wallet application of the user, transmitting, via a crypto-bridge application programming interface (API), fiat currency from a fiat account of the user to a crypto exchange, and receiving, via the crypt-bridge API, an amount of the cryptocurrency based on the payment amount and storing the amount of cryptocurrency in the blockchain wallet, generating an entry comprising a future date, the identifier of the recipient account, and a return value to retrieve from the crypto exchange at the future date, and storing the entry in the queue.

Another example embodiment provides a computer-readable medium comprising instructions, that when read by a processor, cause the processor to perform one or more of receiving a payment amount and an identifier of a recipient account from a digital wallet application of a user, predicting, via a machine learning model, a future value of a cryptocurrency of the cryptocurrency account based on historical values of the cryptocurrency over time, determining to perform a buy-now-pay-later (BNPL) transaction for the payment amount based on the predicted future value of a cryptocurrency stored within the digital wallet application of the user, transmitting, via a crypto-bridge application programming interface (API), fiat currency from a fiat account of the user to a crypto exchange, and receiving, via the crypt-bridge API, an amount of the cryptocurrency based on the payment amount and storing the amount of cryptocurrency in the blockchain wallet, generating an entry comprising a future date, the identifier of the recipient account, and a return value to retrieve from the crypto exchange at the future date, and storing the entry in the queue.

Another example embodiment provides an apparatus that may include a memory device comprising a queue, and a processor configured to receive a payment amount and an identifier of a recipient account from a digital wallet application of a user, the digital wallet application containing a payment card account and a cryptocurrency account, determine to perform a buy-now-pay-later (BNPL) transaction for the payment amount based on current holdings in the payment card account and current holdings in the cryptocurrency account, transmit, via a crypto-bridge application programming interface (API), fiat currency from the payment card account to a crypto exchange, and receive, via the crypt-bridge API, an amount of the cryptocurrency based on the payment amount and store the amount of cryptocurrency in the digital wallet application, generate an entry comprising a future date, the identifier of the recipient account, and a return value to retrieve from the crypto exchange at the future date, and store the entry in the queue.

Another example embodiment provides a method that includes one or more of receiving a payment amount and an identifier of a recipient account from a digital wallet application of a user, the digital wallet application containing a payment card account and a cryptocurrency account, determining to perform a buy-now-pay-later (BNPL) transaction for the payment amount based on current holdings in the payment card account and current holdings in the cryptocurrency account, transmitting, via a crypto-bridge application programming interface (API), fiat currency from the payment card account to a crypto exchange, and receive, via the crypt-bridge API, an amount of the cryptocurrency based on the payment amount and store the amount of cryptocurrency in the digital wallet application, generating an entry comprising a future date, the identifier of the recipient account, and a return value to retrieve from the crypto exchange at a future date, and storing the entry in the queue.

And yet a further example embodiment provides a computer-readable medium comprising instructions, that when read by a processor, cause the processor to perform one or more of receiving a payment amount and an identifier of a recipient account from a digital wallet application of a user, the digital wallet application containing a payment card account and a cryptocurrency account, determining to perform a buy-now-pay-later (BNPL) transaction for the payment amount based on current holdings in the payment card account and current holdings in the cryptocurrency account, transmitting, via a crypto-bridge application programming interface (API), fiat currency from the payment card account to a crypto exchange, and receive, via the crypt-bridge API, an amount of the cryptocurrency based on the payment amount and store the amount of cryptocurrency in the digital wallet application, generating an entry comprising a future date, the identifier of the recipient account, and a return value to retrieve from the crypto exchange at the future date, and storing the entry in the queue.

### BRIEF DESCRIPTION OF THE DRAWINGS

FIGS. 1A-1C are diagrams illustrating a process of determining whether to execute a buy-now-pay-later (BNPL) transaction via a digital wallet according to example embodiments.

FIG. 2A is a diagram illustrating an example blockchain architecture configuration, according to example embodiments.

FIG. 2B is a diagram illustrating a blockchain transactional flow among nodes, according to example embodiments.

FIG. 3A is a diagram illustrating a permissioned network, according to example embodiments.

FIG. 3B is a diagram illustrating another permissioned network, according to example embodiments.

FIG. 3C is a diagram illustrating a permissionless network, according to example embodiments.

FIGS. 4A-4E are diagrams illustrating a process of a BNPL payment transaction of a digital wallet performed via a crypto-bridge API according to example embodiments.

FIGS. 5A-5B are diagrams illustrating methods of executing a BNPL transaction via cryptocurrency according to example embodiments.

FIG. 6A is a diagram illustrating an example system configured to perform one or more operations described herein, according to example embodiments.

FIG. 6B is a diagram illustrating another example system configured to perform one or more operations described herein, according to example embodiments.

FIG. 6C is a diagram illustrating a further example system configured to utilize a smart contract, according to example embodiments.

FIG. 6D is a diagram illustrating yet another example system configured to utilize a blockchain, according to example embodiments.

FIG. 7A is a diagram illustrating a process of a new block being added to a distributed ledger, according to example embodiments.

FIG. 7B is a diagram illustrating data contents of a new data block, according to example embodiments.

FIG. 7C is a diagram illustrating a blockchain for digital content, according to example embodiments.

FIG. 7D is a diagram illustrating a block that may represent the structure of blocks in the blockchain, according to example embodiments.

FIG. 8A is a diagram illustrating an example blockchain that stores machine learning (artificial intelligence) data, according to example embodiments.

FIG. 8B is a diagram illustrating an example quantum-secure blockchain, according to example embodiments.

FIG. 9 is a diagram illustrating an example system that supports one or more of the example embodiments.

### DETAILED DESCRIPTION OF VARIOUS EMBODIMENTS

It will be readily understood that the instant components, as generally described and illustrated in the figures herein, may be arranged and designed in various configurations. Thus, the following detailed description of the embodiments of at least one method, apparatus, non-transitory computer readable medium, and system, as represented in the attached figures, is not intended to limit the application's scope as claimed merely representative of selected embodiments.

The instant features, structures, or characteristics as described throughout this specification may be combined or removed in any suitable manner in one or more embodiments. For example, the phrases “example embodiments,” “some embodiments,” or another similar language throughout this specification refers to the fact that a particular feature, structure, or characteristic described in connection with the embodiment may be included in at least one embodiment. Thus, appearances of the phrases “example embodiments,” “in some embodiments,” “in other embodiments,” or another similar language throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication, even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Example embodiments provide methods, systems, components, non-transitory computer readable media, devices, and/or networks directed to a host platform, such as a digital wallet host, that enables a digital wallet to connect with and communicate with a crypto exchange to perform cryptocurrency transactions via a novel application programming interface (API) referred to herein as a crypto-bridge API. The crypto-bridge API establishes a communication path/channel between the digital wallet application (e.g., a send money service, API, etc.) of the digital wallet application, which may be included in a back-end of the wallet application hosted by a host platform such as a wallet service provider. The front-end of the wallet application, such as mobile application, etc., may be installed on the user's device, such as a mobile phone. Through the example embodiments, the user can use their digital wallet to perform their device's buy-now-pay-later (BNPL) payment transactions. In response, the wallet host provider can utilize the crypto-bridge API to mitigate the payment by leveraging cryptocurrency automatically.

For example, the digital wallet host (e.g., as part of the digital wallet back-end, etc.) may identify whether the user has any cryptocurrency accounts in their digital wallet. If so, the digital wallet host may determine a future value of the cryptocurrency at a future date based on one or more models such as machine learning, statistical models, third-party services which the host platform, and the like. Likewise, the wallet host may predict or otherwise estimate a future value of a fiat currency (e.g., US Dollars, etc.) held in payment accounts such as debit card accounts, credit card accounts, bank accounts, savings accounts, and the like. The host may compare the determined future values of both the fiat currency and the cryptocurrency to determine which account the user uses.

If cryptocurrency is selected, the wallet host may initiate and execute a BNPL transaction for the user based on the cryptocurrency. The BNPL transaction may require multiple steps performed in sequence, with predetermined time spaced between the steps. For example, the host platform may immediately take fiat currency out of a fiat-currency account of the user (e.g., a debit card, credit card, bank account, etc.) and transmit the currency to a crypto exchange server via the crypto-bridge API. The crypto exchange may convert the fiat currency into cryptocurrency and send the cryptocurrency back to the host platform, where it is stored in the user's digital wallet (e.g., in the corresponding cryptocurrency account in the digital wallet, etc.)

In addition, the host platform may start a timer or other mechanism (e.g., time-to-live job, etc.) which expires on a future date. The future data may be days, weeks, months, etc., after exchanging the fiat currency for cryptocurrency. The wallet host may automatically determine the future date or enter by the user. The wallet host may request the user to approve the future date in some embodiments. As another example, the host platform may automatically use the future date.

The wallet host may exchange cryptocurrency held in the digital wallet for fiat currency via the crypto-bridge API when the timer expires. In particular, the wallet host may remove cryptocurrency from the cryptocurrency account in the digital wallet and exchange it for fiat currency via the crypto exchange. In addition, the wallet host may also pause the clearing and settlement of such transactions and place the BNPL transaction in a temporary storage area such as a queue.

In one embodiment, the application utilizes a decentralized database (such as a blockchain), a distributed storage system, including multiple nodes that communicate. The decentralized database includes an append-only immutable data structure resembling a distributed ledger capable of maintaining records between mutually untrusted parties. The untrusted parties are referred to herein as peers or peer nodes. Each peer maintains a copy of the database records, and no single peer can modify the database records without a consensus being reached among the distributed peers.

For example, the blockchain peers may execute a consensus protocol to validate blockchain storage transactions, group the storage transactions into blocks, and build a hash chain over the blocks. This process forms the ledger by ordering the storage transactions, as is necessary, for consistency. A permissioned and/or permissionless blockchain can be used in various embodiments. Anyone can participate without a specific identity in a public or permission-less blockchain. Public blockchains can involve native cryptocurrency and use consensus-based on various protocols such as Proof of Work (PoW). On the other hand, a permissioned blockchain database provides secure interactions among a group of entities that share a common goal but do not fully trust one another, such as businesses that exchange funds, goods, information, and the like.

This application can utilize a blockchain that operates arbitrary, programmable logic tailored to a decentralized storage scheme called “smart contracts” or “chain codes.” In some cases, specialized chain codes may exist for management functions and parameters referred to as system chain codes. The application can further utilize smart contracts, trusted distributed applications that leverage the blockchain database's tamper-proof properties, and an underlying agreement between nodes referred to as an endorsement or endorsement policy. Blockchain transactions associated with this application can be “endorsed” before being committed to the blockchain, while transactions, which are not endorsed, are disregarded. An endorsement policy allows chaincode to specify endorsers for a transaction in the form of a set of peer nodes necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

This application can utilize nodes that are the communication entities of the blockchain system. A “node” may perform a logical function because multiple nodes of different types can run on the same physical server. Nodes are grouped in trust domains and are associated with logical entities that control them in various ways. Nodes may include different types, such as a client or submitting-client node, which submits a transaction invocation to an endorser (e.g., peer) and broadcasts transaction proposals to an ordering service (e.g., ordering node). Another type of node is a peer node which can receive client-submitted transactions, commit the transactions and maintain a state and a copy of the ledger of blockchain transactions. Peers can also have the role of an endorser, although it is not a requirement. An ordering-service-node or orderer is a node running the communication service for all nodes and which implements a delivery guarantee, such as a broadcast to each of the peer nodes in the system when committing transactions and modifying a world state of the blockchain, which is another name for the initial blockchain transaction which typically includes control and setup information.

This application can utilize a ledger that is a sequenced, tamper-resistant record of all state transitions of a blockchain. State transitions may result from chain code invocations (i.e., transactions) submitted by participating parties (e.g., client nodes, ordering nodes, endorser nodes, peer nodes, etc.). Each participating party (such as a peer node) can maintain a copy of the ledger. A transaction may result in asset key-value pairs committed to the ledger as one or more operands, such as creates, updates, deletes, and the like. The ledger includes a blockchain (also referred to as a chain) used to store an immutable, sequenced record in blocks. The ledger also includes a state database that maintains the blockchain's current state.

This application can utilize a transaction log chain structured as hash-linked blocks, and each block contains a sequence of N transactions where N is equal to or greater than one. The block header includes a hash of the block's transactions and the previous block's header. In this way, all transactions on the ledger may be sequenced and cryptographically linked together. Accordingly, it is impossible to tamper with the ledger data without breaking the hash links. A most recently added blockchain block hash represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys included in the chain transaction log. Since the current state represents the latest key values known to a channel, it is sometimes called a world state. Chaincode invocations execute transactions against the current state data of the ledger. To make these chain code interactions efficient, the latest values of the keys may be stored in a state database. The state database may be simply an indexed view into the chain's transaction log; it can therefore be regenerated from the chain. The state database may automatically be recovered (or generated if needed) upon peer node startup and before transactions are accepted.

The current application provides a solution that allows a person in a location (such as a merchant store or an online shopping session) to bring an item into their possession (either by holding the item or placing the item into a cart) and to exit the location, passing through a POS/payment area wherein payment for the items in possession are paid for. In some cases, the payment may occur with or without the person handing the items to the merchant or taking specific action to pay for them. Instead, the host platform engages with the person's digital wallet and completes the transaction based on the best way to pay determined by the host platform. The manner of payment may include different options that are likely to be different for each user. For example, some users may include a crypto account in their digital wallet (or multiple crypto accounts). Users may also include credit cards, debit cards, bank accounts, cryptocurrency accounts, crypto assets, etc. In addition, other payment options such as buy-now-pay-later (BNPL) may also be considered by the system.

For example, a person may attempt to purchase a television for $500 from a merchant. For example, the television may be purchased online, in-store, etc. Initially, the user scans or otherwise types in the details using their wallet application on their device. The details may include a payment amount (e.g., $500), a recipient (e.g., account number of a recipient such as a merchant, cardholder, bank, etc.), an identifier of the item being purchased, an identifier of the user's wallet account (e.g., wallet ID assigned to the front-end of the wallet application installed on the user's device, etc.) In response, the host platform may decide to auto-invest the payment amount in a cryptocurrency and perform a BNPL transaction which holds off on making the payment via fiat currency and instead transfers the money that was going to be used for the payment to a crypto exchange via the crypto-bridge API.

In addition, the wallet host may store an entry in a queue along with a time-to-live (TTL) job that includes a pointer to the entry in the queue. When the TTL job expires, the wallet host may retrieve fiat currency from the crypto exchange via the crypto-bridge API using the cryptocurrency previously obtained from the crypto exchange via the crypto-bridge API. The wallet host may then execute a payment transaction via a traditional electronic payment network such as Banknet, etc., which may require a predefined message format such as ISO 8583, which can be created by the wallet host and submitted to the payment network. The wallet host may execute a payment transaction via another blockchain network or the like.

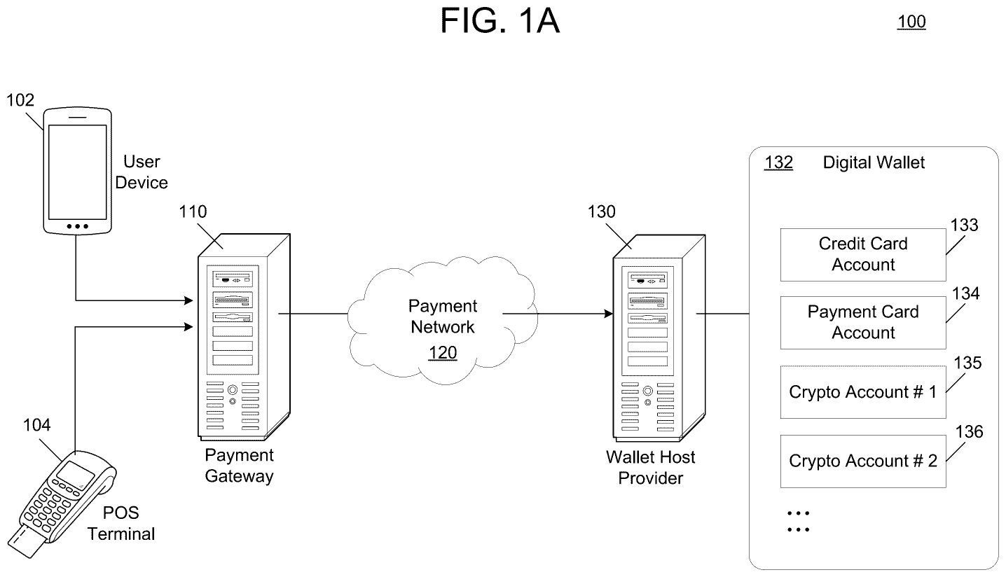

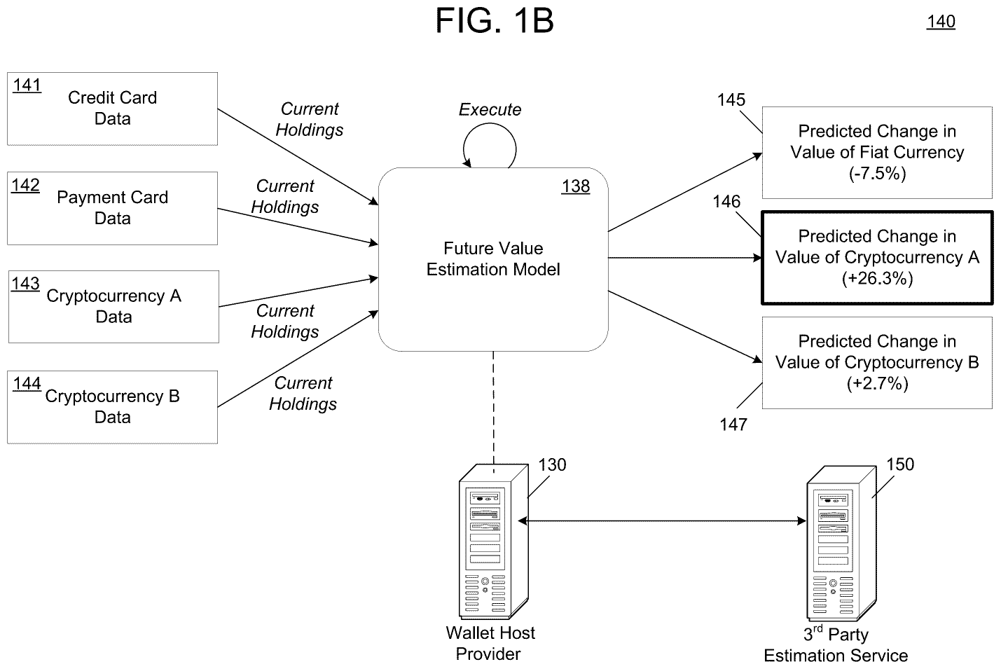

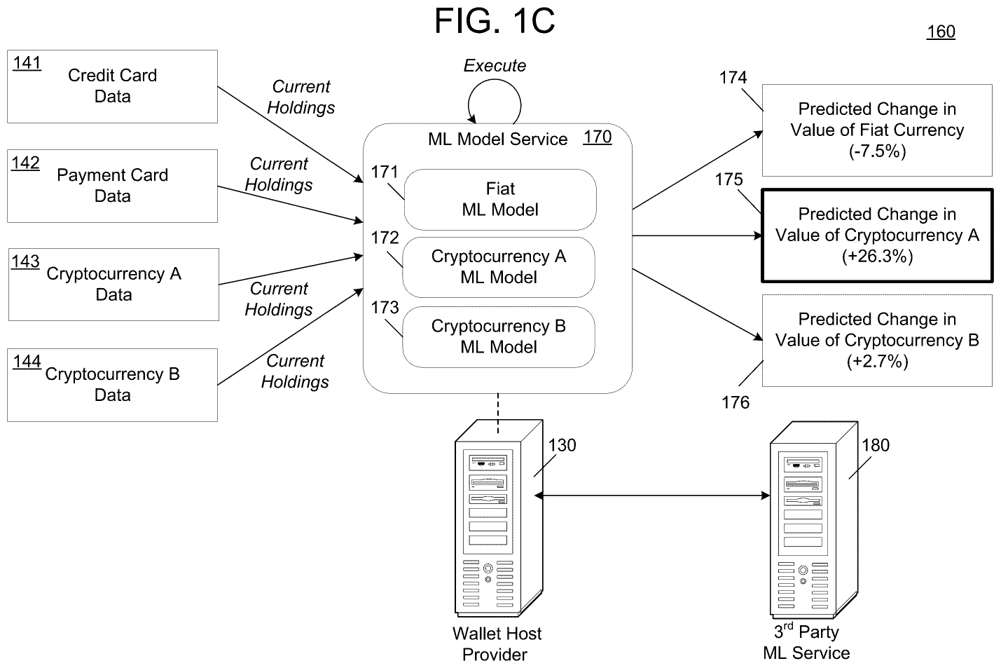

FIGS. 1A-1C illustrates a process of determining whether to execute a buy-now-pay-later (BNPL) transaction via a digital wallet according to example embodiments. For example, FIG. 1A illustrates a process 100 of submitting a fiat-based payment transaction request to a host platform (i.e., wallet host provider 130) through a payment gateway 110 and a payment network 120. For example, the wallet host provider 130 may host a digital wallet application such as a mobile application, including a web server, a cloud platform, a database, a combination of devices, and the like. In this example, a user may install a front-end of a digital wallet application 132 on a user device 102, wherein an interaction between the user device 102 may occur with a POS terminal 104. The back-end of the digital wallet application 132 is hosted by the wallet host provider 130, which may be a web server, an application server, a cloud platform, a blockchain network, and the like.

In FIG. 1A, a user has already digitized a plurality of accounts 133-136 into their digital wallet application instance 132. In this example, account 133 corresponds to the cardholder's credit card account, and account 134 may correspond to a payment card account such as a debit card. Here, the debit card and the credit card may be issued by a financial institution that hosts the digital wallet application 132. However, it should be appreciated that other entities and FI's may issue the fiat-based accounts. Likewise, the user also includes a cryptocurrency account 135 and a cryptocurrency account 136, storing cryptocurrencies of different types.

A payment transaction may be submitted to the wallet host provider 130 from either the user's device 102 or another system such as a merchant POS terminal, an e-commerce platform, another user, and the like. When the payment request is received, the wallet host provider 130 may contact an issuer of the payment card used (e.g., credit card account 133, debit card account 134, etc.) to verify that funds are available. The wallet host provider 130 may approve/authorize the transaction if the funds are available. In addition, the wallet host provider 130 may analyze the future values of the currencies in each of the accounts 133-136 in the digital wallet application 132. Examples of this process are further described below-concerning FIGS. 1B and 1C. In this case, two accounts (accounts 133 and 134) have the same type of currency (fiat currency). Thus, both of these accounts can be evaluated with one model.

In addition, subsequent processing (e.g., clearing, settlement, etc.) of the authorized payment transaction may be delayed or otherwise prevented from moving forward until a future date. Instead, the wallet host provider 130 may create an entry for the transaction and store it in a queue (as described in the examples below). The queued and authorized transaction can then sit and wait while the wallet host provider 130 exchanges an amount of fiat currency (e.g., in the amount of the payment amount, or some other amount, etc.) for cryptocurrency such as a cryptocurrency of one of the cryptocurrency accounts 135 and 136 stored in the digital wallet application 130.

After the proceeds of the cryptocurrency exchange are received (e.g., 10 minutes later, etc.), the wallet host provider 130 may wait until the timer (e.g., TTL, etc.) expires and re-exchange the cryptocurrency for fiat currency. The benefit here is that the user's payment amount is invested in cryptocurrency, which will likely go up due to the amount of time between the request for the payment and the actual execution of the BNPL transaction. Thus, the user may receive interest from the investment, mitigating the purchase transaction cost.

FIG. 1B illustrates a process 140 of estimating a future value of currency via a future value estimation model 138, which may be used by the wallet host provider 130 to determine whether or not to use cryptocurrency and a BNPL transaction as a form of payment. For example, the future value estimation model 138 may be a statistical model, a non-statistical model such as a Grey system theory model, or the like.

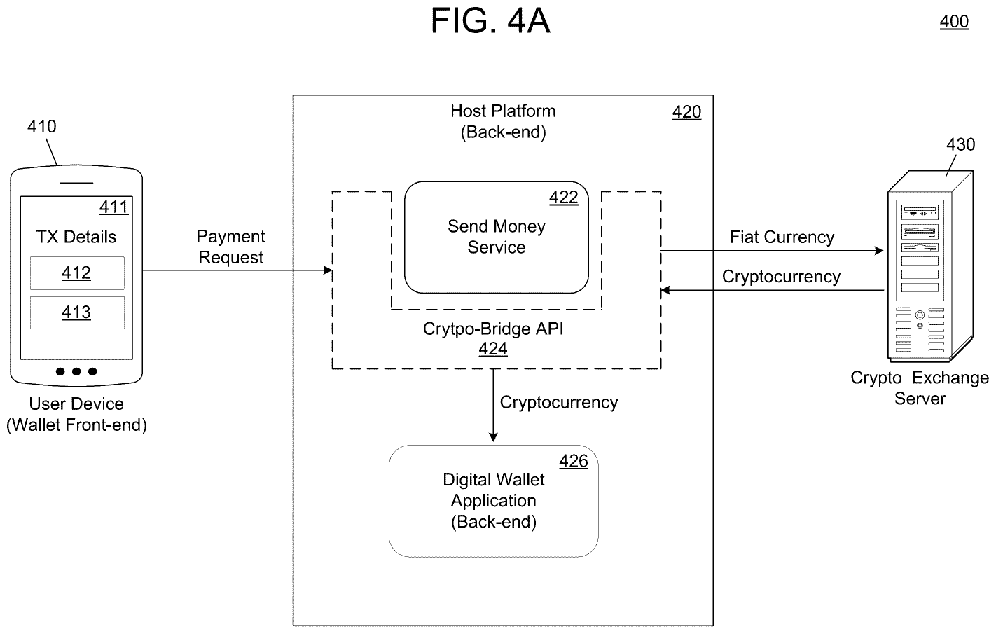

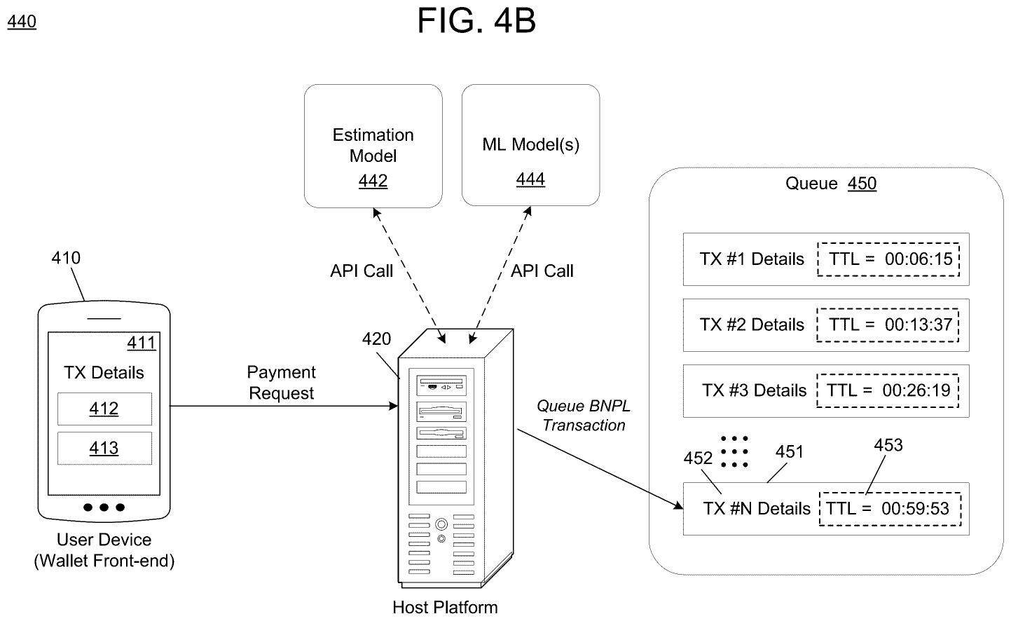

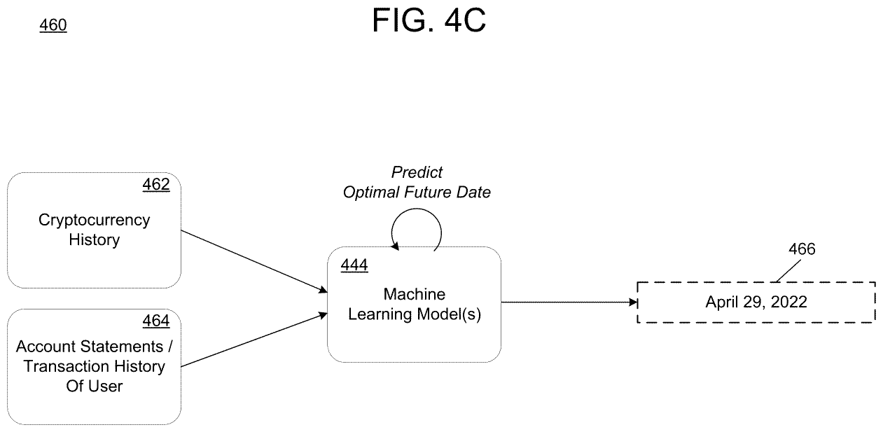

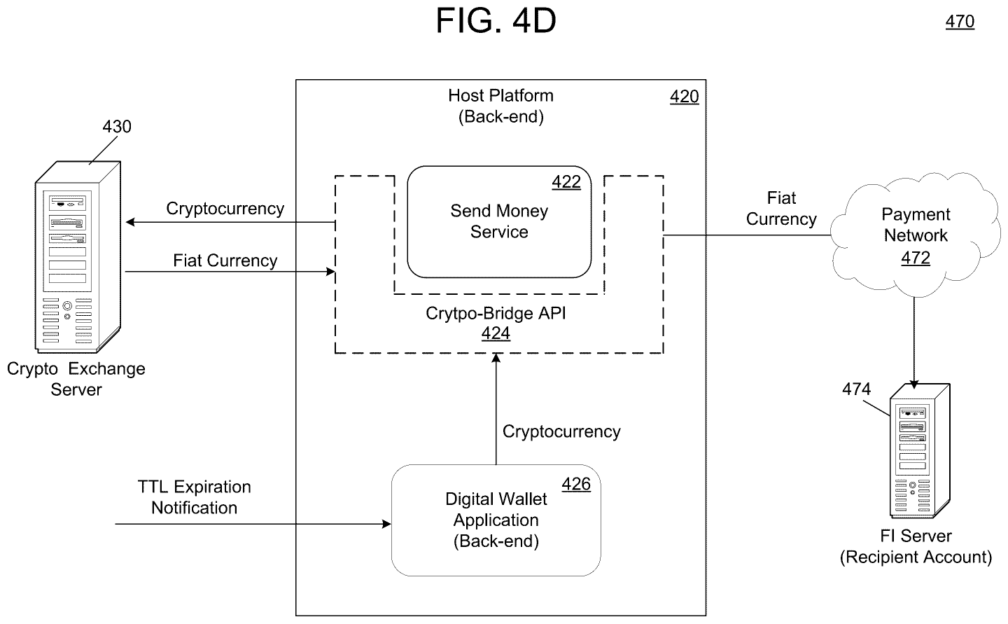

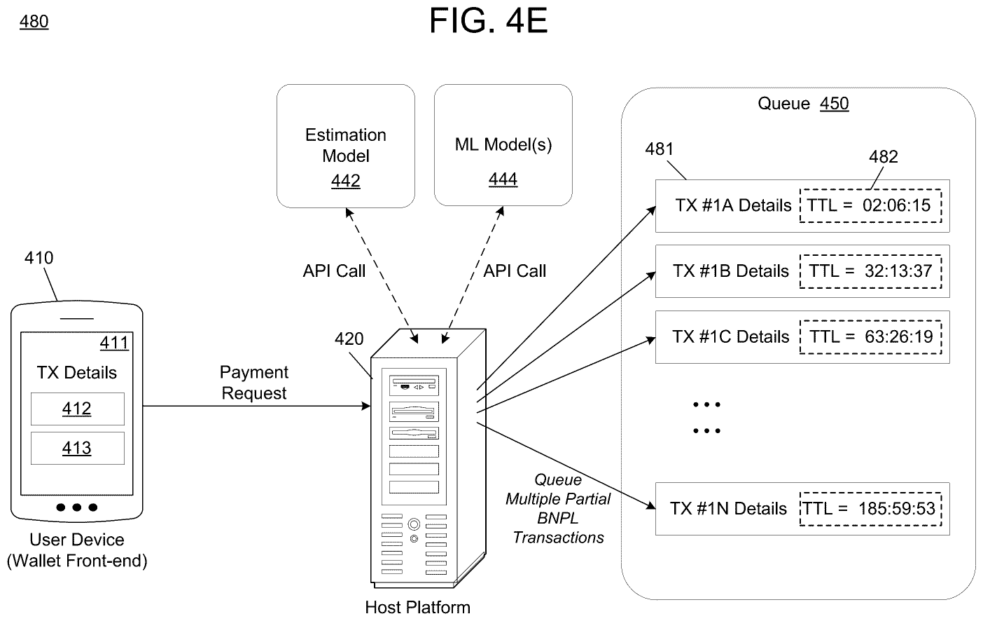

According to various embodiments, the wallet host provider, 130 may look up the payment accounts that are included in the user's digital wallet and obtain account data such as attributes 141, 142, 143, and 144 of the user, as well as current and historical market rates of the respective currencies which may be received from a third-party service provider 150 or accessed from a public database, etc., and input this data into the future value estimation model 138. In response, the future value estimation model 138 may output the estimated future prices of the different currencies on a future date. For example, the future date may be assigned by default as one month away, six months away, one year away, or the like. As another option, and as further described in FIG. 4C, the future date may be determined dynamically based on the currencies' optimal predicted future price.

The future value estimation model 138 may receive identifiers of the accounts that are included in the digital wallet and perform a dynamic determination (e.g., based on market data then, etc.) and the user's usage characters of the different accounts to identify an optimal payment account the user should use. Here, the future value estimation model 138 may obtain attributes associated with each of the accounts, including the attributes 141, 142, 143, and 144, and the trends of the currencies, estimate the future values of the currencies, and output the results which include estimated future values 145, 146, and 147 of fiat currency, cryptocurrency A, and cryptocurrency B, respectively.

With this output, the wallet host provider 130 can determine whether or not to use cryptocurrency or fiat currency. If fiat currency is likely to go up while the cryptocurrencies are likely to go down, the wallet host provider 130 may select to process the payment in a typical fashion via the fiat currency and an electronic payment network. However, if the wallet host provider 130 determines that the cryptocurrency will improve/increase in value at a rate greater than the fiat currency, then the wallet host provider 130 may choose the cryptocurrency and BNPL transaction process. In this example, the wallet host provider determines to use cryptocurrency A based on the output 146 compared to the outputs 145 and 147 corresponding to the estimated future values of fiat currency and cryptocurrency B, respectively.

FIG. 1C illustrates a process 160 of predicting a future value of currency via a machine learning model service 170 that may be hosted by the back-end of the wallet host provider 130 and which may be used by the wallet host provider 130 to determine whether or not to use cryptocurrency and a BNPL transaction as a form of payment. For example, the machine learning model service 170 may include different machine learning models capable of predicting the future value of different currencies. For example, ML model 171 may be used to predict the future value of fiat currency, while ML models 172 and 173 may be used to predict the future value of cryptocurrency A and cryptocurrency B, respectively. As a non-limiting example, the machine learning models 171-173 may include one or more neural networks such as a recurring neural network (RNN), an artificial neural network (ANN), and the like. As another example, the machine learning models 171-173 may include an autoregressive model (e.g., an ARIMA model, etc.), a long-short-term memory (LSTM) model, and the like.

Similar to the example in FIG. 1B, the wallet host provider 130 may look up the payment accounts that are included in the user's digital wallet and obtain account data such as attributes 141, 142, 143, and 144 of the user, as well as current and historical market rates of the respective currencies and predicted future values of the different currencies from a third-party machine-learning service 180. The received data may be input into the machine learning service 170 and one or more of the models 171-173. In response, the machine learning service 170 may output the predicted future prices of the different currencies on a future date. For example, the future date may be assigned by default as one month away, six months away, one year away, or the like. As another option, and as further described in FIG. 4C, the future date may be determined dynamically based on the currencies' optimal predicted future price.

The machine learning service 170 may transform the input data into vectors before inputting the data into one or more ML models 171-173. The machine learning service 170 may output a dynamic determination (e.g., based on market data then, etc.) and the user's usage characters of the different accounts to identify an optimal payment account the user should use. In this example, the outputs include predicted future values 174, 175, and 176 of fiat currency, cryptocurrency A, and cryptocurrency B, respectively.

With this output, the wallet host provider 130 can determine whether or not to use cryptocurrency or fiat currency. If fiat currency is likely to go up while the cryptocurrencies are likely to go down, the wallet host provider 130 may select to process the payment in a typical fashion via the fiat currency and an electronic payment network. However, if the wallet host provider 130 determines that the cryptocurrency will improve/increase in value at a rate greater than the fiat currency, then the wallet host provider 130 may choose the cryptocurrency and BNPL transaction process. In this example, the wallet host provider determines to use cryptocurrency A based on the output 175 compared to the outputs 174 and 176 corresponding to the estimated future values of fiat currency and cryptocurrency B, respectively.

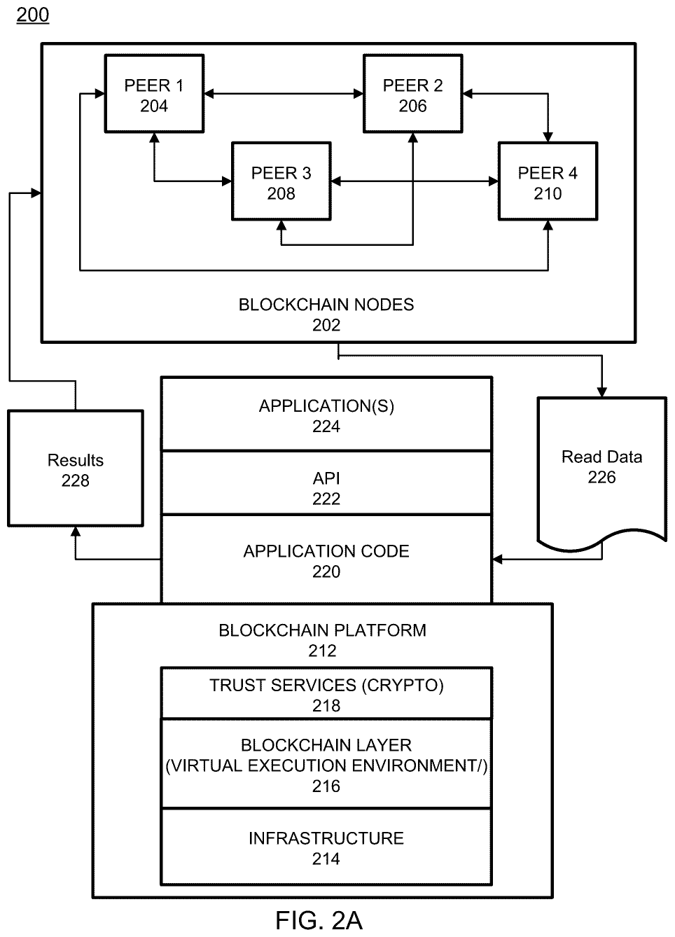

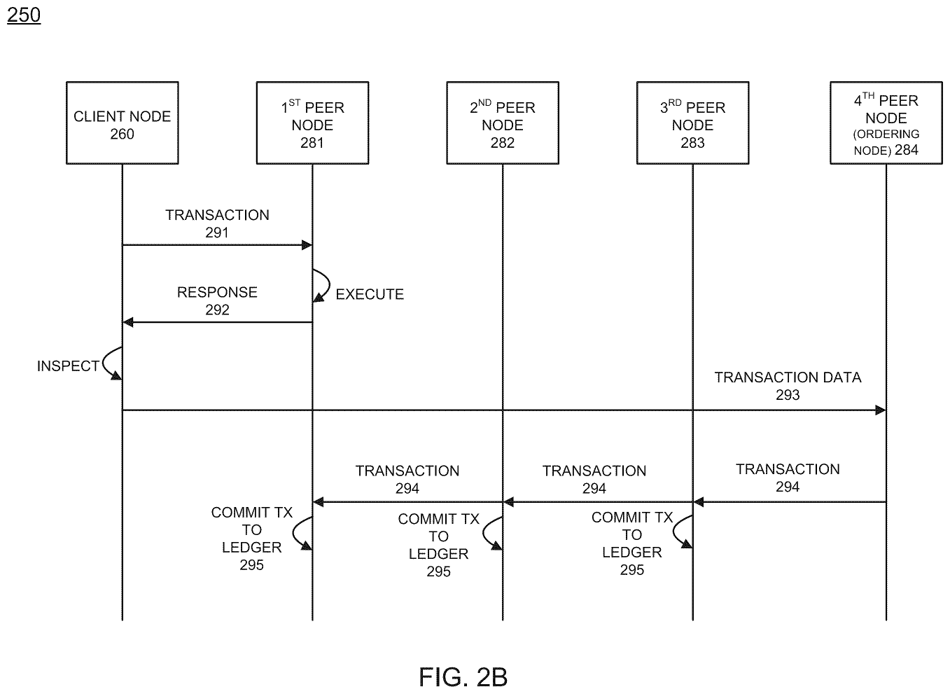

FIG. 2A illustrates a blockchain architecture configuration 200, according to example embodiments. Referring to FIG. 2A, the blockchain architecture 200 may include certain blockchain elements, for example, a group of blockchain nodes 202. Blockchain nodes 202 may include one or more nodes 204-210 (these four nodes are depicted by example only). These nodes participate in several activities, such as blockchain transaction addition and validation process (consensus). One or more blockchain nodes 204-210 may endorse transactions based on endorsement policy and provide an ordering service for all blockchain nodes in the architecture 200. A blockchain node may initiate a blockchain authentication and seek to write to a blockchain immutable ledger stored in blockchain layer 216, a copy of which may also be stored on the underpinning physical infrastructure 214. The blockchain configuration may include one or more applications 224, which are linked to application programming interfaces (APIs) 222 to access and execute stored program/application code 220 (e.g., chain code, smart contracts, etc.), which can be created according to a customized configuration sought by participants and can maintain their state, control their assets, and receive external information. This can be deployed as a transaction and installed via appending to the distributed ledger on all blockchain nodes 204-210.

The blockchain base or platform 212 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2A may process and execute program/application code 220 via one or more interfaces exposed and services provided by blockchain platform 212. Code 220 may control blockchain assets. For example, the code 220 can store and transfer data and may be executed by nodes 204-210 in a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, the smart contract (or chain code executing the logic of the smart contract) may read blockchain data 226, which one or more processing entities may process (e.g., virtual machines) included in the blockchain layer 216 to generate results 228, including alerts, determining liability, and the like, within a complex service scenario. The physical infrastructure 214 may be utilized to retrieve any data or information described herein.

A smart contract may be created via a high-level application and programming language and then written to a block in the blockchain. The smart contract may include executable code which is registered, stored, and/or replicated with a blockchain (e.g., distributed network of blockchain peers). A transaction is an execution of the smart contract code that can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated through one or more consensus protocols throughout the distributed network of blockchain peers.

The smart contract may write data to the blockchain in the format of key-value pairs. Furthermore, the smart contract code can read the values stored in a blockchain and use them in application operations. The smart contract code can write the output of various logic operations into one or more blocks within the blockchain. The code may create a temporary data structure in a virtual machine or another computing platform. Data written to the blockchain can be public and/or encrypted and maintained as private. The temporary data used/generated by the smart contract is held in memory by the supplied execution environment, then deleted once the data needed for the blockchain is identified.

A chain code may include the code interpretation of a smart contract. For example, the chain code may include a packaged and deployable version of the logic within the smart contract. As described herein, the chain code may be program code deployed on a computing network, where it is executed and validated by chain validators together during a consensus process. The chain code may receive a hash and retrieve from the blockchain a hash associated with the data template created using a previously stored feature extractor. If the hashes of the hash identifier and the hash created from the stored identifier template data match, then the chain code sends an authorization key to the requested service. The chain code may write to the blockchain data associated with the cryptographic details.

FIG. 2B illustrates an example of a blockchain transactional flow 250 between blockchain nodes by an example embodiment. Referring to FIG. 2B, the transaction flow may include a client node 260 transmitting a transaction proposal 291 to an endorsing peer node 281. The endorsing peer 281 may verify the client's signature and execute a chain code function to initiate the transaction. The output may include the chaincode results, a set of key/value versions read in the chain code (read set), and keys/values written in chain code (write set). Here, the endorsing peer 281 may determine whether or not to endorse the transaction proposal. If approved, the proposal response 292 is sent back to the client 260 and an endorsement signature. Client 260 assembles the endorsements into a transaction payload 293 and broadcasts it to an ordering service node 284. The ordering service node 284 then delivers ordered transactions as blocks to all peers 281-283 on a channel. Before committal to the blockchain, each peer 281-283 may validate the transaction. For example, the peers may check the endorsement policy to ensure that the correct allotment of the specified peers has signed the results and authenticated the signatures against the transaction payload 293.

Referring again to FIG. 2B, the client node initiates transaction 291 by constructing and sending a request to the peer node 281, an endorser. Client 260 may include an application leveraging a supported software development kit (SDK), utilizing an available API to generate a transaction proposal. The proposal is a request to invoke a chaincode function so that data can be read and/or written to the ledger (i.e., write new key-value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 281 may verify (a) that the transaction proposal is well-formed, (b) the transaction has not been submitted already in the past (replay-attack protection), (c) the signature is valid, and (d) that the submitter (client 260, in the example) is properly authorized to perform the proposed operation on that channel. The endorsing peer node 281 may take the transaction proposal inputs as arguments to the invoked chaincode function. The chain code is then executed against a current state database to produce transaction results, including a response value, read set, and write set. However, no updates are made to the ledger at this point. In 292, the set of values, along with the endorsing peer node's 281 signature, is passed back as a proposal response 292 to the SDK of the client 260, which parses the payload for the application to consume.

In response, the application of the client 260 inspects/verifies the endorsing peer's signatures and compares the proposal responses to determine if the proposal response is the same. If the chaincode only queried the ledger, the application would inspect the query response and typically not submit the transaction to the ordering node service 284. Suppose the client application intends to submit the transaction to the ordering node service 284 to update the ledger. The application determines if the specified endorsement policy has been fulfilled before submitting (i.e., did all peer nodes necessary for the transaction endorse the transaction). Here, the client may include only one of the multiple parties to the transaction. Each client may have their endorsing node, and each endorsing node will need to endorse the transaction. The architecture is such that even if an application selects not to inspect responses or otherwise forwards an unendorsed transaction, peers' endorsement policy will still be enforced and upheld at the commit validation phase.

After successful inspection, the client 260 assembles endorsements into a transaction proposal and broadcasts the transaction proposal and response within a transaction data message 293 to the ordering node 284. The transaction may contain the read/write sets, the endorsing peer's signatures, and a channel ID. The ordering node 284 does not need to inspect the entire content of a transaction to perform its operation. Instead, the ordering node 284 may receive transactions from all channels in the network, order them chronologically by channel, and create blocks of transactions per channel.

The blocks are delivered, in a transaction message 294, from the ordering node 284 to all peer nodes 281-283 on the channel. The data section within the block may be validated to ensure an endorsement policy is fulfilled and that there have been no changes to the ledger state for read set variables since the transaction execution generated the read set. Furthermore, in step 295, each peer node 281-283 appends the block to the channel's chain, and for each valid transaction, the write sets are committed to a current state database. An event may be emitted to notify the client application that the transaction (invocation) has been immutably appended to the chain and notify whether the transaction was validated or invalidated.

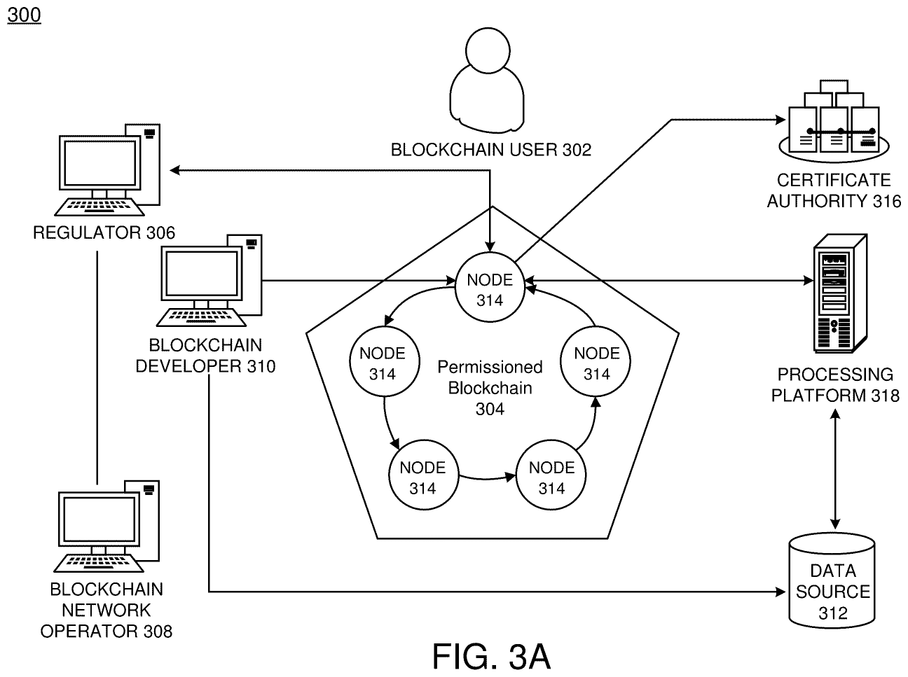

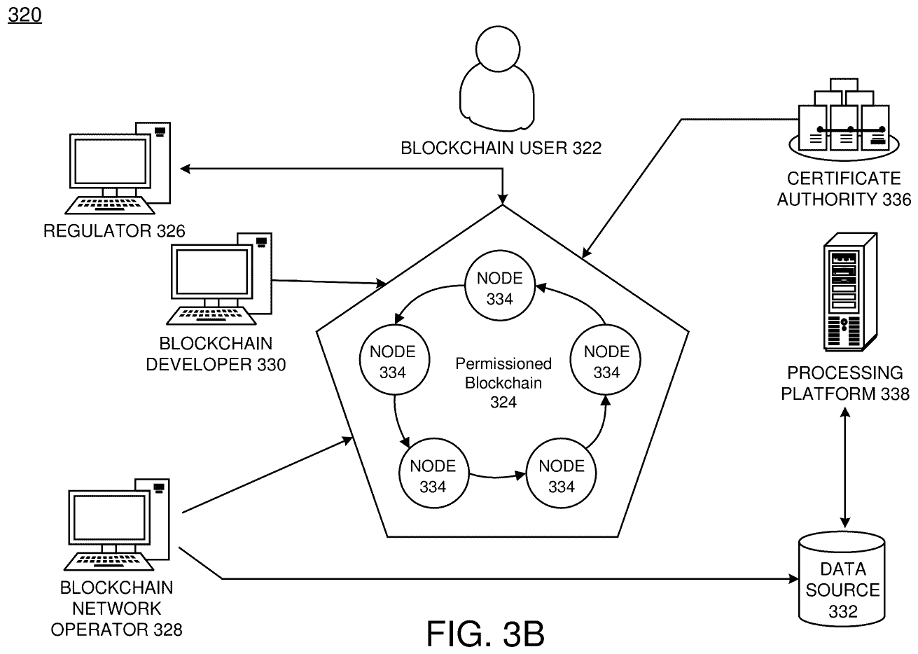

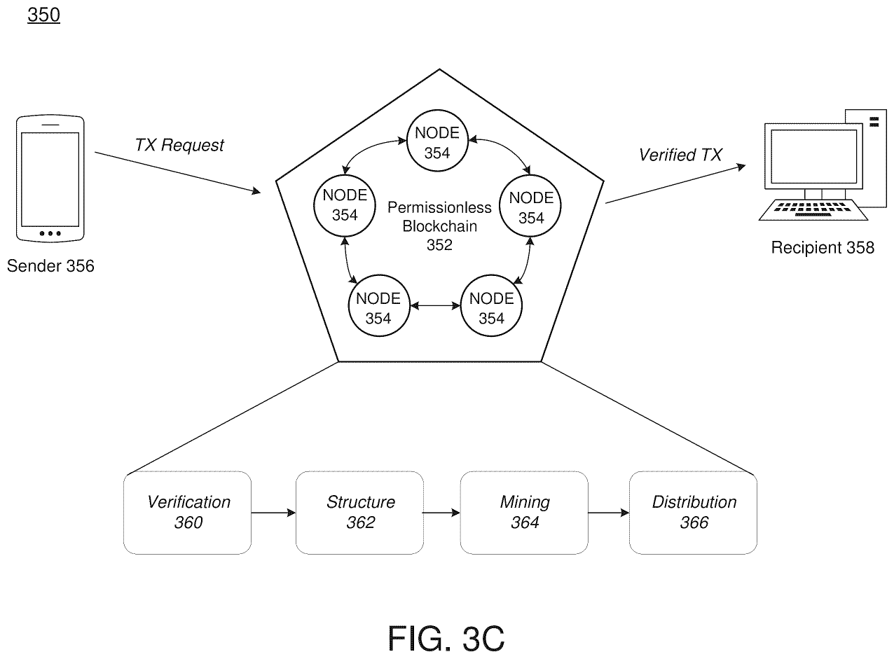

FIG. 3A illustrates an example of a permissioned blockchain network 300, which features a distributed, decentralized peer-to-peer architecture. In this example, a blockchain user 302 may initiate a transaction to the permissioned blockchain 304. In this example, the transaction can be a deploy, invoke, or query and may be issued through a client-side application leveraging an SDK, directly through an API, etc. Networks may provide access to a regulator 306, such as an auditor. A blockchain network operator 308 manages member permissions by enrolling the regulator 306 as an “auditor” and the blockchain user 302 as a “client.” An auditor could be restricted only to querying the ledger, whereas a client could be authorized to deploy, invoke, and query certain types of chain code.

A blockchain developer 310 can write chain code and client-side applications. The blockchain developer 310 can deploy chaincode directly to the network through an interface. To include credentials from a traditional data source 312 in chain code, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions.

In some cases, blockchain users must possess these digital certificates to transact on the permissioned blockchain 304. Meanwhile, a user attempting to utilize chain code may be required to verify their credentials on the traditional data source 312. To confirm the user's authorization, chain code can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client.” An auditor could be restricted only to querying the ledger, whereas a client could be authorized to deploy, invoke, and query certain types of chain code.

A blockchain developer 330 writes chaincode and client-side applications. The blockchain developer 330 can deploy chaincode directly to the network through an interface. To include credentials from a traditional data source 332 in chain code, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336.

In some cases, blockchain users must possess these digital certificates to transact on the permissioned blockchain 324. Meanwhile, a user attempting to utilize chain code may be required to verify their credentials on the traditional data source 332. To confirm the user's authorization, chain code can use an out-of-band connection to this data through a traditional processing platform 338.

In some embodiments, the blockchain herein may be permissionless. In contrast with permissioned blockchains, which require permission to join, anyone can join a permissionless blockchain. For example, to join a permissionless blockchain, a user may create a personal address and begin interacting with the network by submitting transactions and adding entries to the ledger. Additionally, all parties choose to run a node on the system and employ the mining protocols to help verify transactions.

FIG. 3C illustrates a process 350 of a transaction processed by a permissionless blockchain 352, including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide a user interface controls and a display of transaction parameters. The transaction is broadcast throughout the blockchain 352 to the nodes 354. Depending on the blockchain's 352 network parameters, the nodes verify 360 the transaction based on rules (which may be pre-defined or dynamically allocated) established by the permissionless blockchain 352 creators. For example, this may include verifying the identities of the parties involved, etc. The transaction may be verified immediately or placed in a queue with other transactions, and the nodes 354 determine if the transactions are valid based on a set of network rules.

In structure 362, valid transactions are formed into a block and sealed with a lock (hash). Mining nodes may perform this process among the nodes 354. Mining nodes may utilize additional software specifically for mining and creating blocks for the permissionless blockchain 352. Each block may be identified by a hash (e.g., 256-bit number, etc.) created using an algorithm agreed upon by the network. Each block may include a header, a pointer or reference to a hash of a previous block's header in the chain, and a group of valid transactions. The previous block's hash reference is associated with creating the secure independent chain of blocks.

Before blocks can be added to the blockchain, the blocks must be validated. Validation for the permissionless blockchain 352 may include a proof-of-work (PoW) solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW, thereby ensuring correct answers. In other words, a potential solution must prove that computing resources were drained in solving the problem. In some permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks for the modifications of one block to be accepted. Furthermore, as new blocks are mined, the difficulty of modifying a block is increased, and the number of subsequent blocks increases. With distribution 366, the successfully validated block is distributed through the permissionless blockchain 352, and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

The example embodiments may include various steps performed by entities involved in the identity-based encryption scheme. A transferer transfers an asset to a transferee (receiver) via a blockchain in the example embodiments. However, contrary to a traditional blockchain network, the transaction can be executed on the blockchain before the transferee is onboarded to the blockchain in the example embodiments. This process can benefit the buyer who is not yet a member of the blockchain, such as a real estate purchase or the like. To perform the transfer, the blockchain network may create a temporary blockchain address to hold (and technically own) the asset until the transferee is successfully onboarded to the blockchain.

FIGS. 4A-4D illustrates a process of a BNPL payment transaction of a digital wallet performed via a crypto-bridge API according to example embodiments. Referring to FIG. 4A illustrated is a process 400 of a payment authorization request message received from a digital wallet application. In this example, the payment request is received from a user device 410 of a wallet owner. However, it should also be appreciated that the payment request may be received from multiple other systems such as a merchant's POS terminal, a bank, an e-commerce platform, another user, and the like. The payment authorization request message includes a payment transaction, such as a credit card transaction, a debit card transaction, or the like, which is received by a host platform 420 (wallet host provider, etc.) The payment authorization request message may be in a format predefined for electronic payment networks such as ISO 8583, etc., which is configured to be transferred along the rails of an electronic payment network such as Bank net.

In response, the host platform 420 may identify a PAN or digital wallet identifier within the request and a corresponding digital wallet hosted by the host platform that includes one or more payment accounts contained therein. For example, the host platform 420 may detect whether the user has any cryptocurrency accounts in their wallet. In response, the host platform 420 may pause the payment transaction processing and create a temporary entry of the payment transaction within a temporary storage structure (as further described in the example of FIG. 4B). For example, the temporary storage structure may be a queue, a buffer, a file, a document, a spreadsheet, an XML, file, a JSON document, or the like. The host platform 420 has time to perform additional processing by pausing the payment transaction, such as determining whether to perform a BNPL transaction based on cryptocurrency instead of the requested fiat-currency-based transaction.

To enable this process, the host platform 420 includes a crypto-bridge API 424 installed within the digital wallet back-end or otherwise coupled to the back-end, which establishes a communication pathway between the wallet application (such as a send money service 422 of the wallet application, or the like) and a crypto exchange server 430. The crypto-bridge API 424 may indicate and enforce a message type used to communicate with the crypto exchange server 430. In addition, or instead, the crypto-bridge API 424 may enforce one or more of the message content (message field types, value types, methods, etc.), handlers, communication pathways/URLs, etc.

Thus, the host platform 420 can automatically invest fiat currency from a payment account (such as a debit card or a credit card) within the user's digital wallet application 426. For example, the host platform 420 may pull or otherwise obtain money from one or more fiat-based accounts in the user's digital wallet application 426 held on the back-end and input via the user on the front-end. The fiat currency may be pulled from a debit card account, a credit card account, a bank account, a savings account, etc., and transmitted from the send money service 422 or other service of the digital wallet application 426 to the crypto exchange server 430 via the crypto-bridge API 424. In response, the crypto exchange 430 corresponds to the amount of fiat currency (minus any fees, etc.) In doing so, the wallet application can preserve a payment for a later time in an automated manner and decide, on behalf of the user, to invest their payment in a cryptocurrency as part of a BNPL/cryptocurrency transaction.

FIG. 4B illustrates a process 440 of the host platform 420 determining to perform the BNPL transaction and also creating and storing an entry for the BNPL transaction in a temporary storage such as a queue 450, which may be included within the digital wallet application or coupled to it via secure authentication such as a username/password, integrity checks, authentication handshake, etc.

In this example, a new transaction request or payment request is received from a user device 410 by the host platform 420. For example, the user may enter values into fields 412, 413, etc., within a user interface 411 of a front-end of the digital wallet application installed on the user device 410 and submit the data to the application's back-end the host platform 420. In response, the host platform 420 may call one or more models 442 and 444 to determine a future value of the different currencies currently held in the user's wallet application, based on the current holdings (i.e., the current amount of value stored in each account, etc.). The call may be in the form of an API call to either an estimation model 442 or a machine learning model 444. Examples of the estimation model 442 are described in FIG. 1B and examples of the machine learning model 444 are described in FIG. 1C.

For example, the host platform 420 may call the estimation model 442. In response, the estimation model 442 may determine that cryptocurrency is better to use right now than fiat currency based on predicted/estimated future values of the cryptocurrency concerning the fiat currency. In response, the host platform may generate an entry 451 and add it to the queue 450. Entry 451 may be stored within the queue 450 based on the future date at which the BNPL payment is to be processed. In this example, details of the payment, such as the wallet ID of the user, the recipient account of the BNPL payment, a fiat-payment method which is to perform the BNPL payment, and the like, within transaction details 452 in the entry 451.

In some embodiments (although not required), the host platform 420 may instantiate a time-to-live job 453 on the host platform, which counts down from a predetermined amount of time. For example, the time-to-live job 453 may be a cron job but is not limited thereto. In addition, the host platform 420 may write a pointer into the time-to-live job 453, which points to the entry 451 within the queue 450. For example, an identifier of the entry 451, such as a queue ID, may be stored within the time-to-live job 453.

FIG. 4C illustrates a process 460 of predicting an optimal future date 466 for a payment to occur for a BNPL transaction according to various embodiments. In this example, the host platform, such as the wallet host provider, may execute or otherwise call a machine learning model(s) 444 to predict an optimal payment date for the BNPL transaction. Here, the model 444 may receive input data such as cryptocurrency value history over time 462, account statements of the user 464 (both cryptocurrency and fiat currency), and the like. In response, the model 444 may predict a target/optimal future date 466 for re-converting the cryptocurrency back into fiat currency and performing the BNPL payment.

In some embodiments, the host platform may also populate a user interface of the front-end of the digital wallet on the user's device with a request or a prompt to have the user “approve” of the optimal future date before the host platform incorporates the date into the transaction processing. As another example, the host platform may automatically use the optimal future date 466 output by model 444. For example, the user may configure settings within a menu of the digital wallet application, which automatically performs the cryptocurrency investment and the BNPL transaction.

FIG. 4D illustrates a process 470 of re-exchanging the cryptocurrency pulled from the crypto exchange server 430 during the process 400 of FIG. 4A. In this example, the time-to-live job 453 expires, and a notification is sent to the host platform 420/digital wallet application 426. In response, the host platform 420 pulls cryptocurrency out of the user's cryptocurrency account in the digital wallet application 426 and exchanges it for fiat currency from the crypto exchange server 430 via the crypto-bridge API 424. In response, the crypto exchange server 430 sends the fiat currency to the host platform 420 via the crypto-bridge API. Furthermore, the host platform 420 can execute an electronic payment transaction via a payment network 472 to transfer the fiat currency from the user to a recipient account stored at a financial institution (FI) server 474 of the recipient's account. Thus, the payment can be satisfied later than initially requested in an automated fashion by the host platform 420.

FIG. 4E illustrates a process 480 of investing a payment amount in a cryptocurrency before it is due according to example embodiments. As in the other examples already described herein, the host platform 420 may automatically decide to invest an amount of fiat currency equal to all or some of the amount of the payment transaction in a cryptocurrency. For example, a user may have a monetary account (user bank account) set aside, which the host platform 420 can use to take funds from and invest them into a cryptocurrency prior/?to the user's payment is due on the user's bank account. In this example, though, rather than make one payment to satisfy the BNPL transaction, the host platform may make multiple partial payments spread out/distributed over time with additional time (e.g., one week, one month, etc.) between the partial payments.

The host platform 420 may generate a plurality of entries 481 within the queue 450 for a shared/common payment request. In this example, each entry 481 may include a partial repayment amount (e.g., the same amount or different amounts at each interval) and a different timer/TTL job 482, enabling the host platform 420 incrementally sequentially make the payment over time. In doing so, the investment process can be maintained for an even longer amount (at least for some of the payment amount), enabling the user to earn more interest.

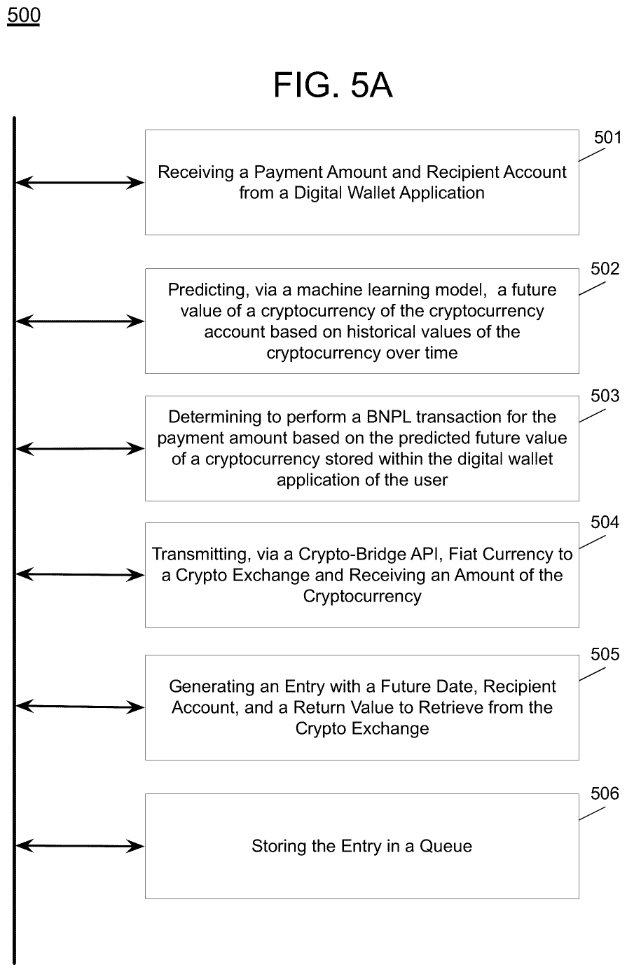

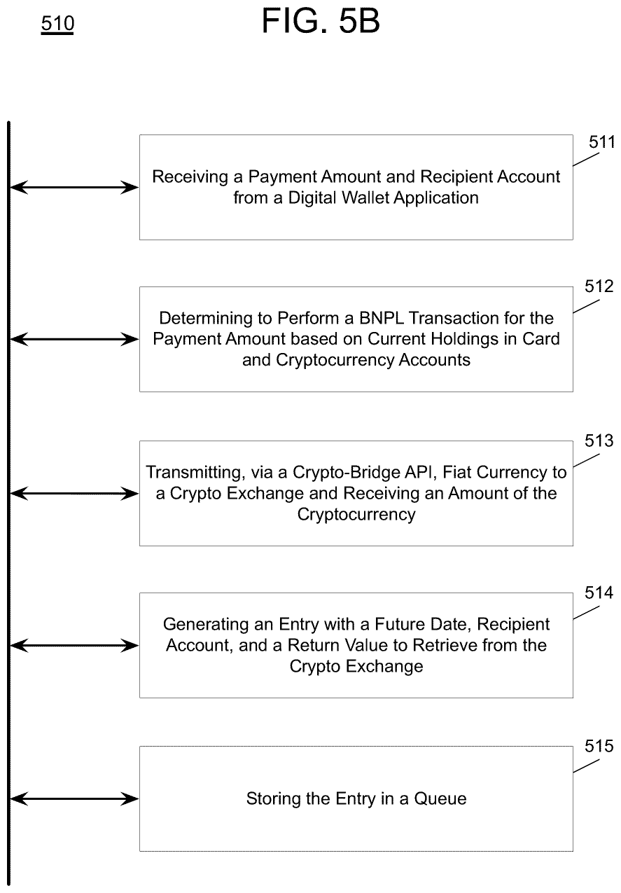

FIG. 5A illustrates a method 500 of executing a BNPL transaction via cryptocurrency according to example embodiments. Referring to FIG. 5A, in 501, the method may include receiving a payment amount and an identifier of a recipient account from a digital wallet application of a user. In 502, the method may include predicting a future value of a cryptocurrency of the cryptocurrency account based on historical values over time via a machine learning model. In 503, the method may include determining to perform a buy-now-pay-later (BNPL) transaction for the payment amount based on the predicted future value of a cryptocurrency stored within the digital wallet application of the user.

In 504, the method may include transmitting, via a crypto-bridge application programming interface (API), fiat currency from a fiat account of the user to a crypto exchange, and receiving, via the crypt-bridge API, an amount of the cryptocurrency based on the payment amount and storing the amount of cryptocurrency in the blockchain wallet. In 505, the method may include generating an entry comprising a future date, the identifier of the recipient account, and a return value to retrieve from the crypto exchange at a future date. In 506, the method may include storing the entry in the queue.

In some embodiments, the method may further include predicting, via another machine learning model, an optimal future date for exchanging the cryptocurrency for fiat currency with the crypto exchange and requesting the user to accept the optimal future date as the future date via the digital wallet application of the user. In some embodiments, the crypto-bridge API establishes a communication channel and a message format for communications between a send money service of the digital wallet application and the crypto exchange. In some embodiments, the method may further include retrieving fiat currency from the crypto exchange via the crypto-bridge API based on a transfer of the cryptocurrency stored in the digital wallet application of the user to the crypto exchange and executing a payment transaction that transfers the fiat currency to the recipient.

In some embodiments, the method may further include executing a time-to-live job that expires on the future date and storing a pointer to the entry stored in the queue within the time-to-live job. In some embodiments, the generating may include generating a plurality of entries, wherein each entry comprises a different respective future date, the identifier of the recipient account, and a partial return amount to retrieve from the crypto exchange at a future date, and storing the plurality of entries in the queue. In some embodiments, the method may further include retrieving a plurality of partial amounts of the payment amount in fiat currency from the crypto exchange via the crypto-bridge API based on the plurality of entries in the queue at the plurality of different respective future dates and transmitting a plurality of payment card transactions to the recipient account based on the plurality of retrieved partial amounts.

FIG. 5B illustrates a method 510 of executing a BNPL transaction via cryptocurrency according to example embodiments. Referring to FIG. 5B, in 511, the method may include receiving a payment amount and an identifier of a recipient account from a digital wallet application of a user, the digital wallet application containing a payment card account, and a cryptocurrency account. In 512, the method may include determining to perform a buy-now-pay-later (BNPL) transaction for the payment amount based on current holdings in the payment card account and current holdings in the cryptocurrency account.

In 513, the method may include transmitting, via a crypto-bridge application programming interface (API), fiat currency from the payment card account to a crypto exchange and receiving, via the crypt-bridge API, an amount of the cryptocurrency based on the payment amount and store the amount of cryptocurrency in the digital wallet application. In 514, the method may further include generating an entry comprising a future date, the identifier of the recipient account, and a return value to retrieve from the crypto exchange at the future date. In 515, the method may include storing the entry in the queue.

In some embodiments, the determining may include estimating a future value of the current holdings in the cryptocurrency account based on historical values of the cryptocurrency over time and a future value of the current holdings of the payment card account based on historical values of a fiat currency over time. In some embodiments, the determining may include determining to perform the BNPL transaction in response to the predicted future value of the cryptocurrency compared to the predicted future value of the fiat currency.

In some embodiments, the crypto-bridge API may establish a communication channel and a message format for communication between a send money service of the digital wallet application and the crypto exchange. In some embodiments, the method may further include detecting the occurrence of the future date, retrieving fiat currency from the crypto exchange via the crypto-bridge API based on a transfer of the cryptocurrency stored in the digital wallet application to the crypto exchange, and executing a payment transaction which transfers the fiat currency to the recipient. In some embodiments, the generating may further include executing a time-to-live job that expires on the future date and storing a pointer to the entry stored in the queue within the time-to-live job.

In some embodiments, the generating may include generating a plurality of entries, each entry comprising a different respective future date, the identifier of the recipient account, and a partial return amount to retrieve from the crypto exchange at the future date, and storing the plurality of entries in the queue. In some embodiments, the method may further include retrieving a plurality of partial return amounts of the payment amount in fiat currency from the crypto exchange via the crypto-bridge API based on the plurality of entries in the queue at the plurality of different respective future dates and transmit a plurality of payment card transactions to the recipient account with the plurality of partial return amounts based on the plurality of retrieved partial amounts.

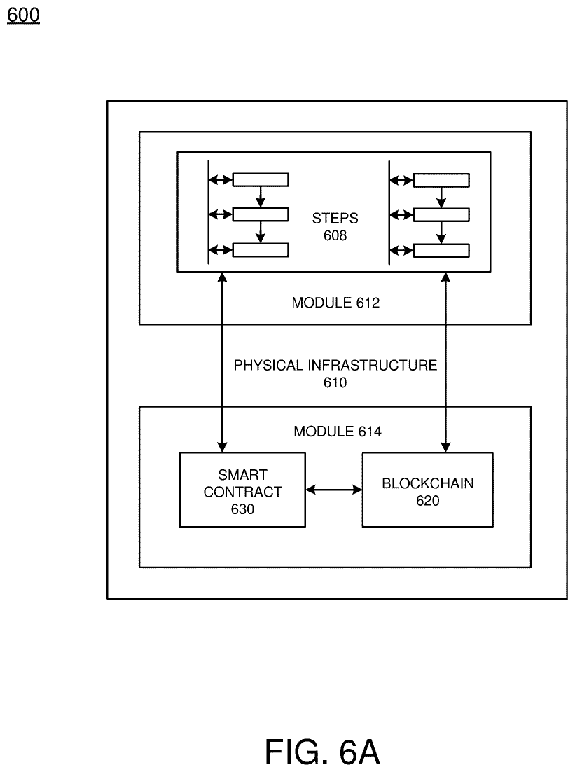

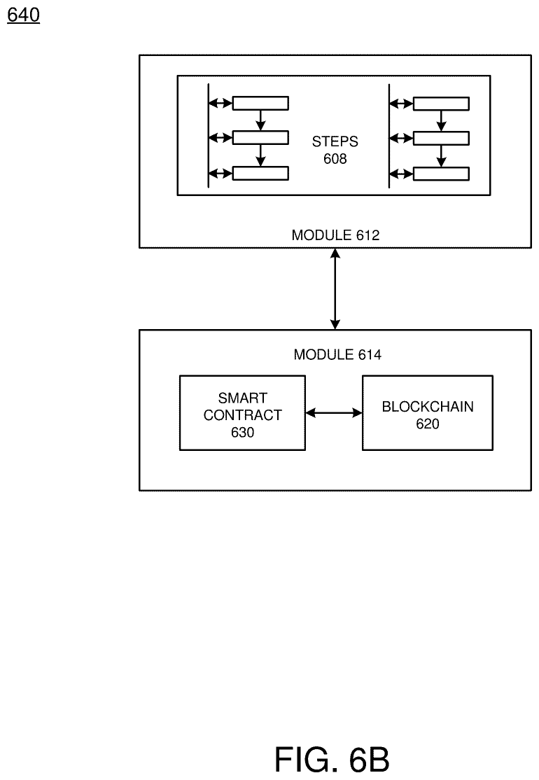

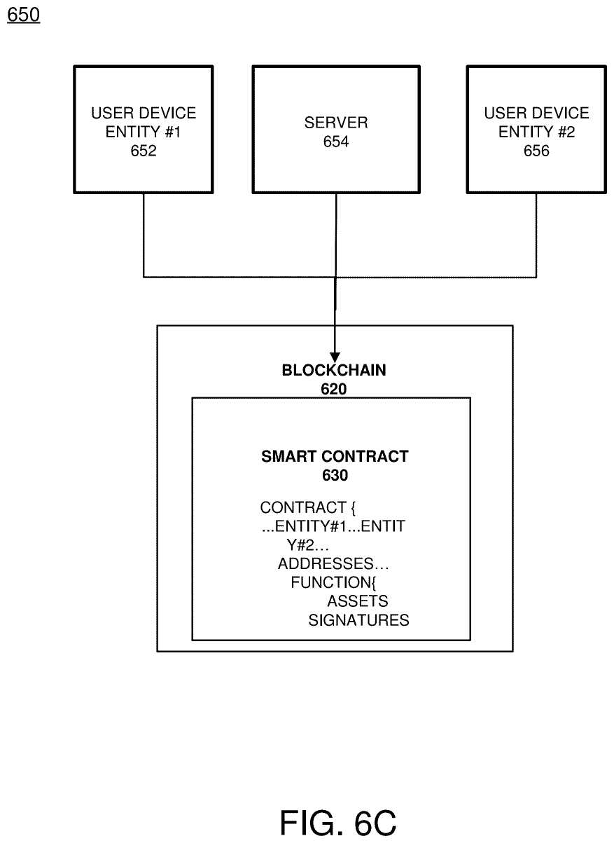

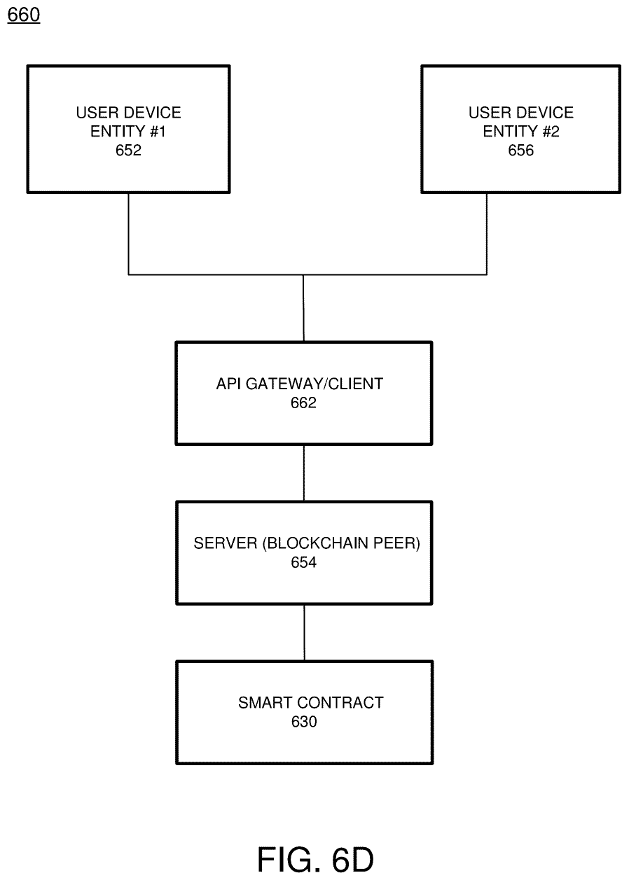

FIG. 6A illustrates an example system 600 with a physical infrastructure 610 configured to perform various operations according to example embodiments. Referring to FIG. 6A, the physical infrastructure 610 includes a module 612 and a module 614. The module 614 includes a blockchain 620 and a smart contract 630 (which may reside on the blockchain 620), which may execute any operational steps 608 (in module 612) included in any example embodiments. The steps/operations 608 may include one or more of the embodiments described or depicted and may represent output or written information written or read from one or more smart contracts 630 and/or blockchains 620. The physical infrastructure 610, the module 612, and the module 614 may include one or more computers, servers, processors, memories, and/or wireless communication devices. Further, the module 612 and the module 614 may be a same module.

FIG. 6B illustrates another example system 640 configured to perform various operations according to example embodiments. Referring to FIG. 6B, the system 640 includes a module 612 and a module 614. The module 614 includes a blockchain 620 and a smart contract 630 (which may reside on the blockchain 620), which may execute any operational steps 608 (in module 612) included in any example embodiments. The steps/operations 608 may include one or more of the embodiments described or depicted and may represent output or written information written or read from one or more smart contracts 630 and/or blockchains 620. The physical infrastructure 610, the module 612, and the module 614 may include one or more computers, servers, processors, memories, and/or wireless communication devices. Further, the module 612 and the module 614 may be a same module.

FIG. 6C illustrates an example system configured to utilize a smart contract configuration among contracting parties and a mediating server configured to enforce the smart contract terms on the blockchain according to example embodiments. Referring to FIG. 6C, the configuration 650 may represent a communication session, an asset transfer session, or a process or procedure driven by a smart contract 630, which explicitly identifies one or more user devices 652 and/or 656. The smart contract execution, operations, and results may be managed by a server 654. Content of the smart contract 630 may require digital signatures by one or more of the entities 652 and 656, which are parties to the smart contract transaction. The smart contract execution results may be written to a blockchain 620 as a blockchain transaction. The smart contract 630 resides on the blockchain 620, which may reside on one or more computers, servers, processors, memories, and/or wireless communication devices.

FIG. 6D illustrates a system 660, including a blockchain, according to example embodiments. Referring to the example of FIG. 6D, an application programming interface (API) gateway 662, provides a common interface for accessing blockchain logic (e.g., smart contract 630 or other chain code) and data (e.g., distributed ledger, etc.). In this example, the API gateway 662 is a common interface for performing transactions (invoke, queries, etc.) on the blockchain by connecting one or more entities 652 and 656 to a blockchain peer (i.e., server 654). Here, the server 654 is a blockchain network peer component that holds a copy of the world state and a distributed ledger allowing clients 652 and 656 to query data on the world state as well as submit transactions into the blockchain network where depending on the smart contract 630 and endorsement policy, endorsing peers will run the smart contracts 630.

The above embodiments may be implemented in hardware, in a computer program executed by a processor, firmware, or a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). Alternatively, the processor and the storage medium may reside as discrete components.

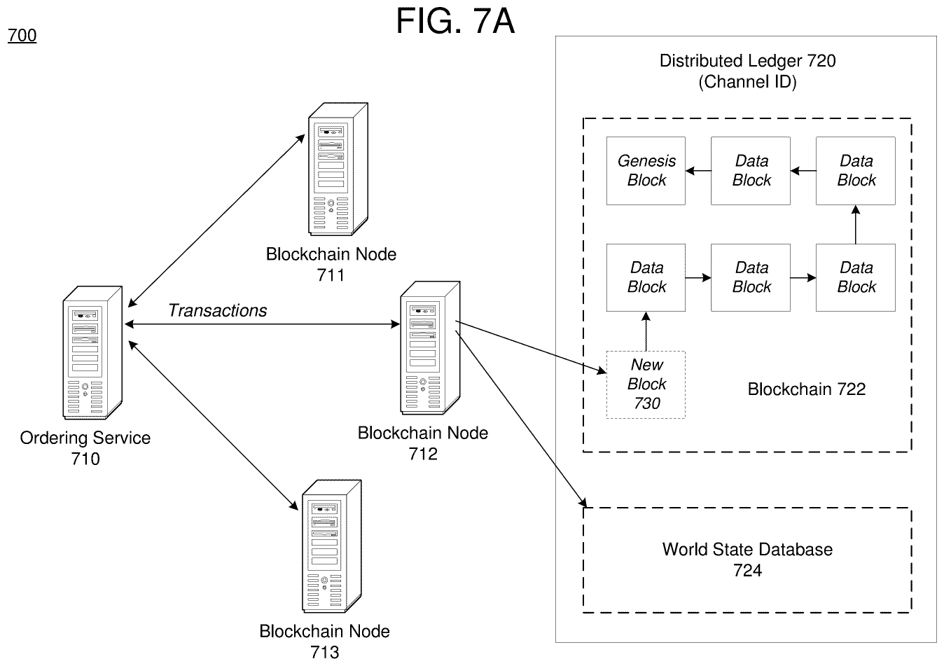

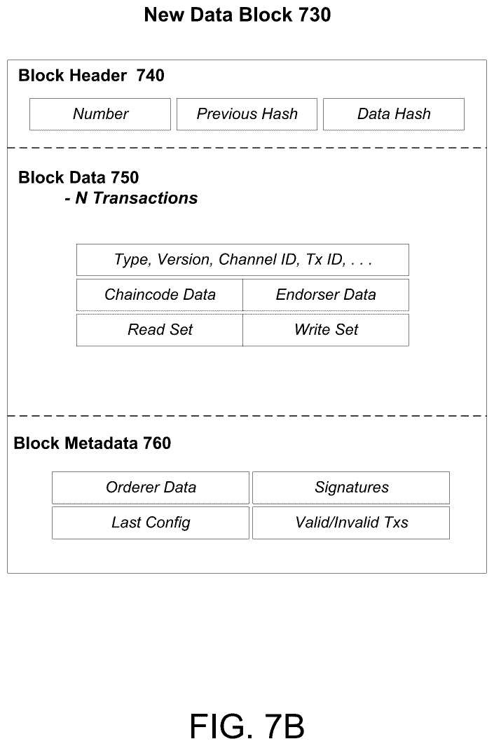

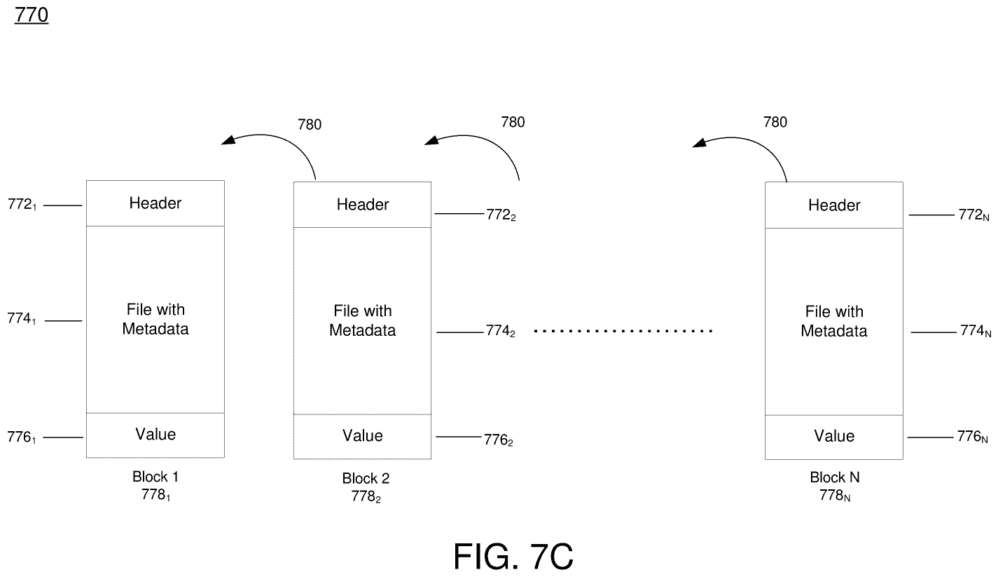

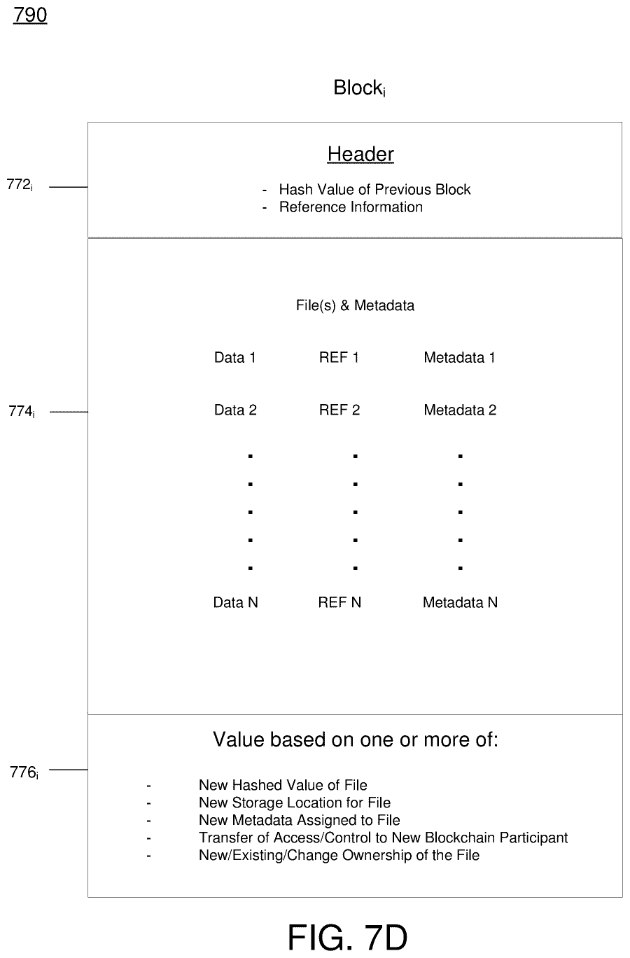

FIG. 7A illustrates a process 700 of a new block is added to a distributed ledger 720, according to example embodiments and FIG. 7B illustrates contents of a new data block structure 730 for blockchain, according to example embodiments. Referring to FIG. 7A, clients (not shown) may submit transactions to blockchain nodes 711, 712, and/or 713. Clients may be instructions received from any source to enact activity on the blockchain 720. For example, clients may be applications that act on behalf of a requester, such as a device, person, or entity, to propose transactions for the blockchain. The plurality of blockchain peers (e.g., blockchain nodes 711, 712, and 713) may maintain a state of the blockchain network and a copy of the distributed ledger 720. Different types of blockchain nodes/peers may be present in the blockchain network, including endorsing peers, which simulate and endorse transactions proposed by clients, and committing peers, which verify endorsements, validate transactions, and commit transactions to the distributed ledger 720. In this example, the blockchain nodes 711, 712, and 713 may perform the role of endorser node, committer node, or both.

The distributed ledger 720 includes a blockchain that stores immutable, sequenced records in blocks and a state database 724 (current world state), maintaining a current state of the blockchain 722. One distributed ledger 720 may exist per channel, and each peer maintains its copy of the distributed ledger 720 for each channel they are a member of. The blockchain 722 is a transaction log structured as hash-linked blocks where each block contains a sequence of N transactions. Blocks may include various components, such as shown in FIG. 7B. The linking of the blocks (shown by arrows in FIG. 7A) may be generated by adding a hash of a prior block's header within a block header of a current block. In this way, all transactions on the blockchain 722 are sequenced and cryptographically linked together, preventing tampering with blockchain data without breaking the hash links. Furthermore, the latest block in the blockchain 722 represents every transaction before it because of the links. The blockchain 722 may be stored on a peer file system (local or attached storage), supporting an append-only blockchain workload.

The current state of the blockchain 722 and the distributed ledger 722 may be stored in the state database 724. Here, the current state data represents the latest values for all keys ever included in the chain transaction log of the blockchain 722. Chaincode invocations execute transactions against the current state in the state database 724. To make these chain code interactions extremely efficient, the latest values of all keys are stored in the state database 724. The state database 724 may include an indexed view into the transaction log of the blockchain 722; it can therefore be regenerated from the chain at any time. Upon peer startup, the state database 724 may automatically recover (or generate if needed) before accepted transactions.

Endorsing nodes receive transactions from clients and endorse the transaction based on simulated results. Endorsing nodes hold smart contracts which simulate the transaction proposals. When an endorsing node endorses a transaction, the endorsing nodes create a transaction endorsement, a signed response from the endorsing node to the client application indicating the endorsement of the simulated transaction. The method of endorsing a transaction depends on an endorsement policy which may be specified within the chain code. An example of an endorsement policy is “most endorsing peers must endorse the transaction.” Different channels may have different endorsement policies. Endorsed transactions are forward by the client application to ordering service 710.

The ordering service 710 accepts endorsed transactions, orders them into a block and delivers the blocks to the committing peers. For example, the ordering service 710 may initiate a new block when a threshold of transactions has been reached, a timer times out, or another condition. In the example of FIG. 7A, blockchain node 712 is a committing peer that has received a new data block 730 for storage on blockchain 720. The first block in the blockchain may be referred to as a genesis block which includes information about the blockchain, its members, the data stored therein, etc.

The ordering service 710 may be made up of a cluster of orderers. The ordering service 710 does not process transactions, smart contracts, or maintain the shared ledger. Instead, the ordering service 710 may accept the endorsed transactions and specifies the order in which those transactions are committed to the distributed ledger 720. The architecture of the blockchain network may be designed such that the specific implementation of ‘ordering’ (e.g., Solo, Kafka, BFT, etc.) becomes a pluggable component.

Transactions are written to the distributed ledger 720 in a consistent order. The order of transactions is established to ensure that the updates to the state database 724 are valid when they are committed to the network. Unlike a cryptocurrency blockchain system (e.g., Bitcoin, etc.), where ordering occurs through solving a cryptographic puzzle, or mining, in this example, the parties of the distributed ledger 720 may choose the ordering mechanism that best suits that network.

When the ordering service 710 initializes a new data block 730, the new data block 730 may be broadcast to committing peers (e.g., blockchain nodes 711, 712, and 713). In response, each committing peer validates the transaction within the new data block 730 by checking to ensure that the read set and the write set still match the current world state in the state database 724. The committing peer can determine whether the read data that existed when the endorsers simulated the transaction is identical to the current world state in the state database 724. When the committing peer validates the transaction, the transaction is written to the blockchain 722 on the distributed ledger 720, and the state database 724 is updated with the write data from the read-write set. If a transaction fails, that is, if the committing peer finds that the read-write set does not match the current world state in the state database 724, the transaction ordered into a block will still be included in that block, but it will be marked as invalid, and the state database 724 will not be updated.

Referring to FIG. 7B, a new data block 730 (also referred to as a data block) stored on the blockchain 722 of the distributed ledger 720, may include multiple data segments such as a block header 740, block data 750 (block data section), and block metadata 760. It should be appreciated that the various depicted blocks and their contents, such as new data block 730 and its contents, are shown in FIG. 7B are merely examples and are not meant to limit the scope of the example embodiments. In a conventional block, the data section may store transactional information of N transaction(s) (e.g., 1, 10, 100, 500, 1000, 2000, 3000, etc.) within the block data 750.

The new data block 730 may also include a link to a previous block (e.g., on the blockchain 722 in FIG. 7A) within the block header 740. In particular, the block header 740 may include a hash of a previous block's header. The block header 740 may also include a unique block number, a hash of the block data 750 of the new data block 730, and the like. The block number of the new data block 730 may be unique and assigned in various orders, such as an incremental/sequential order starting from zero.

The block metadata 760 may store multiple metadata fields (e.g., as a byte array, etc.). Metadata fields may include a signature on block creation, a reference to the last configuration block, a transaction filter identifying valid and invalid transactions within the block, the last offset persisted of an ordering service that ordered the block, and the like. The signature, the last configuration block, and the orderer metadata may be added by the ordering service 710. Meanwhile, a committing node of the block (such as blockchain node 712) may add validity/invalidity information based on an endorsement policy, verification of reading/write sets, and the like. The transaction filter may include a byte array of a size equal to the number of transactions included in the block data 750 and a validation code identifying whether a transaction was valid/invalid.

FIG. 7C illustrates an embodiment of a blockchain 770 for digital content by the embodiments described herein. The digital content may include one or more files and associated information. The files may include media, images, video, audio, text, links, graphics, animations, web pages, documents, or other forms of digital content. The immutable, append-only aspects of the blockchain serve as a safeguard to protect the integrity, validity, and authenticity of the digital content, making it suitable for use in legal proceedings where admissibility rules apply or other settings where evidence is taken into consideration or where the presentation and use of digital information are otherwise of interest. In this case, the digital content may be referred to as digital evidence.

The blockchain may be formed in various ways. The digital content may be included in and accessed from the blockchain itself in one embodiment. For example, each blockchain block may store a hash value of reference information (e.g., header, value, etc.) along with the associated digital content. The hash value and associated digital content may then be encrypted together. Thus, the digital content of each block may be accessed by decrypting each block in the blockchain, and the hash value of each block may be used as a basis to reference a previous block. This may be illustrated as follows:

| Block 1 | Block 2 | . . . | Block N |
|---|---|---|---|
| Hash Value 1 | Hash Value 2 | | Hash Value N |
| Digital Content 1 | Digital Content 2 | | Digital Content N |

The digital content may not be included in the blockchain in one embodiment. For example, the blockchain may store the encrypted hashes of the content of each block without any of the digital content. The digital content may be stored in another storage area or memory address in association with the hash value of the original file. The other storage area may be the same storage device used to store the blockchain, a different storage area, or even a separate relational database. The digital content of each block may be referenced or accessed by obtaining or querying the hash value of a block of interest and then looking up that has value in the storage area, which is stored in correspondence with the actual digital content. This operation may be performed, for example, by a database gatekeeper. This may be illustrated as follows:

| Blockchain | Storage Area |
|---|---|
| Block 1 Hash Value | Block 1 Hash Value . . . Content |
| . . . | . . . |
| Block N Hash Value | Block N Hash Value . . . Content |

In the example embodiment of FIG. 7C, the blockchain 770 includes several blocks 778₁, 778₂, . . . 778_{N} cryptographically linked in an ordered sequence, where N≥1. The encryption used to link the blocks 778₁, 778₂, . . . 778_{N} may be any of several keyed or un-keyed Hash functions. In one embodiment, the blocks 778₁, 778₂, . . . 778_{N} are subject to a hash function that produces n-bit alphanumeric outputs (where n is 256 or another number) from inputs based on information in the blocks. Examples of such a hash function include, but are not limited to, an SHA-type (SHA stands for Secured Hash Algorithm) algorithm, Merkle-Damgard algorithm, HAIFA algorithm, Merkle-tree algorithm, nonce-based algorithm, and a non-collision-resistant PRF algorithm. In another embodiment, the blocks 778₁, 778₂, . . . , 778_{N} may be cryptographically linked by a different function from a hash function. For illustration purposes, the following description is made concerning a hash function, e.g., SHA-2.

Each block 778₁, 778₂, . . . , 778_{N} in the blockchain includes a header, a version of the file, and a value. The header and the value are different for each block due to hashing in the blockchain. In one embodiment, the value may be included in the header. As described in greater detail below, the file version may be the original file or a different version of the original file.

The first block, 778₁ in the blockchain, is the genesis block and includes the header 772₁, original file 774₁, and an initial value of 776₁. The hashing scheme used for the genesis block, and indeed in all subsequent blocks, may vary. For example, all the information in the first block 778₁ may be hashed together at one time, or each or a portion of the information in the first block 778₁ may be separately hashed, and then a hash of the separately hashed portions may be performed.

The header 772₁ may include one or more initial parameters, which, for example, may include a version number, timestamp, nonce, root information, difficulty level, consensus protocol, duration, media format, source, descriptive keywords, and/or other information associated with original file 774₁ and/or the blockchain. The header 772₁ may be generated automatically (e.g., by blockchain network managing software) or manually by a blockchain participant. Unlike the header in other blocks 778₂ to 778_{N} in the blockchain, the header 772₁ in the genesis block does not reference a previous block simply because there is no previous block.

The original file 774₁ in the genesis block may be, for example, data as captured by a device with or without processing before its inclusion in the blockchain. The original file 774₁ is received through the system's interface from the device, media source, or node. The original file 774₁ is associated with metadata, which, for example, may be generated by a user, the device, and/or the system processor, either manually or automatically. The metadata may be included in the first block 778₁ associated with the original file 774₁.

The value 776₁ in the genesis block is an initial value generated based on one or more unique attributes of the original file 774₁. In one embodiment, the one or more unique attributes may include the hash value for the original file 774₁, metadata for the original file 774₁, and other information associated with the file. In one implementation, the initial value of 776₁ may be based on the following unique attributes:
1) SHA-2 computed hash value for the original file
2) originating device ID
3) starting timestamp for the original file
4) initial storage location of the original file
5) blockchain network member ID for software to currently control the original file and associated metadata

The blockchain's other blocks, 778₂ to 778_{N}, also have headers, files, and values. However, unlike the first block, 772₁, each of the headers 772₂ to 772_{N} in the other blocks includes the hash value of an immediately preceding block. The hash value of the immediately preceding block may be just the hash of the header of the previous block or may be the hash value of the entire previous block. By including the hash value of a preceding block in each of the remaining blocks, a trace can be performed from the Nth block back to the genesis block (and the associated original file) on a block-by-block basis, as indicated by arrows 780, to establish an auditable and immutable chain-of-custody.

Each of the header 772₂ to 772_{N} in the other blocks may also include other information, e.g., version number, timestamp, nonce, root information, difficulty level, consensus protocol, and/or other parameters or information associated with the corresponding files and/or the blockchain in general.

The files 774₂ to 774_{N} in the other blocks may be equal to the original file or may be a modified version of the original file in the genesis block depending, for example, on the type of processing performed. The type of processing performed may vary from block to block. The processing may involve, for example, any modification of a file in a preceding block, such as redacting information or otherwise changing the content of, taking information away from, or adding or appending information to the files.

Additionally, or alternatively, the processing may involve merely copying the file from a preceding block, changing a storage location of the file, analyzing the file from one or more preceding blocks, moving the file from one storage or memory location to another, or performing action relative to the file of the blockchain and/or its associated metadata. Processing that involves analyzing a file may include, for example, appending, including, or otherwise associating various analytics, statistics, or other information associated with the file.

The values in each of the other blocks, 776₂ to 776_{N} in the other blocks, are unique and all different due to the processing performed. For example, the value in any one block corresponds to an updated version of the value in the previous block. The update is reflected in the block's hash to which the value is assigned. Therefore, the values of the blocks indicate what processing was performed in the blocks and permit a tracing through the blockchain back to the original file. This tracking confirms the chain of custody of the file throughout the entire blockchain.

For example, consider the case where portions of the file in a previous block are redacted, blocked out, or pixelated to protect the person's identity shown in the file. The block including the redacted file will include metadata associated with the redacted file, e.g., how the redaction was performed, who performed the redaction, timestamps where the redaction(s) occurred, etc. The metadata may be hashed to form the value. Because the metadata for the block is different from the information that was hashed to form the value in the previous block, the values are different from one another and may be recovered when decrypted.

In one embodiment, the value of a previous block may be updated (e.g., a new hash value computed) to form the value of a current block when any one or more of the following occurs. In this example embodiment, the new hash value may be computed by hashing all or a portion of the information noted below.
a) new SHA-2 computed hash value if the file has been processed in any way (e.g., if the file was redacted, copied, altered, accessed, or some other action was taken)
b) new storage location for the file
c) new metadata identified associated with the file
d) transfer of access or control of the file from one blockchain participant to another blockchain participant

FIG. 7D illustrates an embodiment of a block that may represent the structure of the blocks in the blockchain 790 by one embodiment. The block, Blockᵢ, includes a header 772ᵢ, a file 774ᵢ, and a value 776ᵢ.

The header 772ᵢ includes a hash value of a previous block Blockᵢ₋₁ and additional reference information, which, for example, may be any of the types of information (e.g., header information including references, characteristics, parameters, etc.) discussed herein. All blocks reference the hash of a previous block except, of course, the genesis block. The previous block's hash value may be just a hash of the header in the previous block or a hash of all or a portion of the information in the previous block, including the file and metadata.

The file 774ᵢ includes a plurality of data, such as Data 1, Data 2, . . . , Data N in sequence. The data are tagged with Metadata 1, Metadata 2, . . . , Metadata N which describe the content and/or characteristics of the data. For example, the metadata for each data may include information to indicate a timestamp for the data, process the data, keywords indicating the persons or other content depicted in the data, and/or other features that may be helpful to establish the validity and content of the file as a whole, and particularly its use a digital evidence, for example, as described in connection with an embodiment discussed below. In addition to the metadata, each data may be tagged with reference REF₁, REF₂, . . . , REF_{N} to a previous data to prevent tampering, gaps in the file, and sequential reference through the file.

Once the metadata is assigned to the data (e.g., through a smart contract), the metadata cannot be altered without the hash changing, which can easily be identified for invalidation. The metadata, thus, creates a data log of information that may be accessed for use by participants in the blockchain.

The value 776ᵢ is a hash value or other value computed based on any of the types of information previously discussed. For example, for any given block Blockᵢ, the value for that block may be updated to reflect the processing that was performed for that block, e.g., new hash value, new storage location, new metadata for the associated file, transfer of control, or access, identifier, or other action or information to be added. Although the value in each block is shown to be separate from the metadata for the data of the file and header, the value may be based, in part or whole, on this metadata in another embodiment.

Once the blockchain 770 is formed, at any point in time, the immutable chain-of-custody for the file may be obtained by querying the blockchain for the transaction history of the values across the blocks. This query, or tracking procedure, may begin with decrypting the value of the block that is most currently included (e.g., the last (N^{th}) block) and then decrypt the other until the genesis block is reached, the original file is recovered. The decryption may also involve decrypting the headers and files and associated metadata at each block.

Decryption is performed based on the type of encryption in each block. This may involve private keys, public keys, or a public-private key pair. For example, when asymmetric encryption is used, blockchain participants or a processor in the network may generate a public key and private key pair using a predetermined algorithm. The public and private keys are associated through some mathematical relationship. The public key may be distributed publicly to serve as an address to receive messages from other users, e.g., an IP address or home address. The private key is kept secret and used to sign messages sent to other blockchain participants digitally. The signature is included in the message so that the recipient can verify using the sender's public key. The recipient can confirm that only the sender could have sent this message.

Generating a key pair may be analogous to creating an account on the blockchain, but without having actually to register anywhere. Also, every transaction executed on the blockchain is digitally signed by the sender using their private key. This signature ensures that only the account owner can track and process (if within the scope of permission determined by a smart contract) the blockchain file.

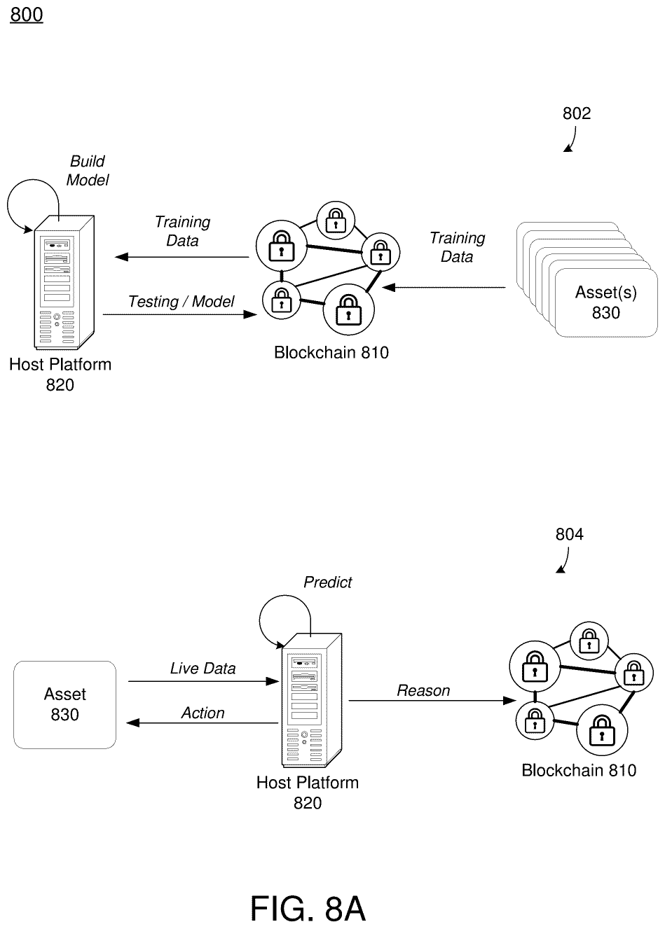

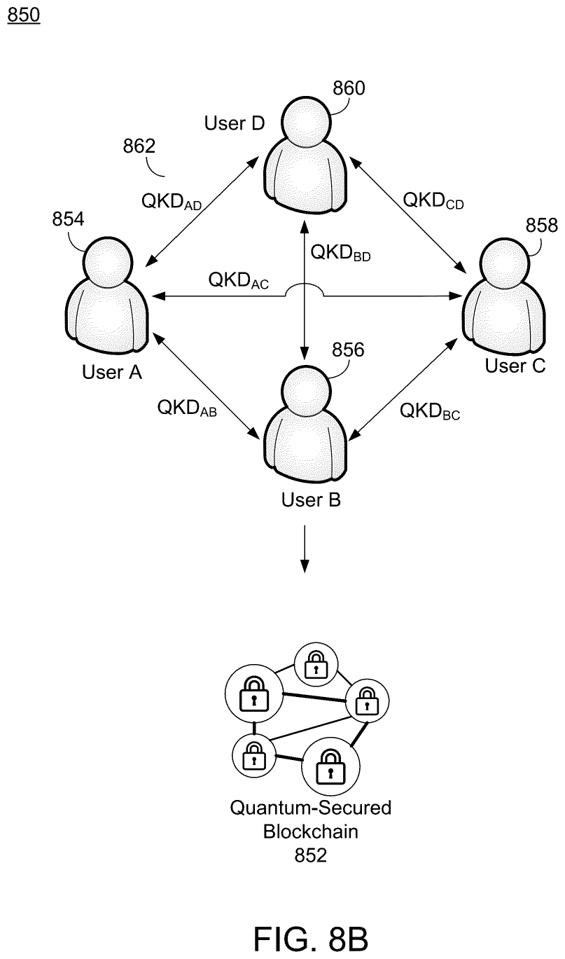

FIGS. 8A and 8B illustrate additional examples of use cases for blockchain which may be incorporated and used herein. In particular, FIG. 8A illustrates an example 800 of a blockchain 810, which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 8A, a host platform 820, builds and deploys a machine learning model for predictive monitoring of assets 830. Here, the host platform 820 may be a cloud platform, an industrial server, a web server, a personal computer, a user device, and the like. Assets 830 can be any type of asset (e.g., machine or equipment, etc.) such as an aircraft, locomotive, turbine, medical machinery and equipment, oil and gas equipment, boats, ships, vehicles, and the like. As another example, assets 830 may be non-tangible assets such as stocks, currency, digital coins, insurance, etc.

The blockchain 810 can be used to significantly improve both a training process 802 of the machine learning model and a predictive process 804 based on a trained machine learning model. For example, in 802, rather than requiring a data scientist/engineer or other user to collect the data, historical data may be stored by the assets 830 themselves (or through an intermediary, not shown) on the blockchain 810. This can significantly reduce the collection time needed by the host platform 820 when performing predictive model training. For example, using smart contracts, data can be directly and reliably transferred straight from its place of origin to the blockchain 810. By using the blockchain 810 to ensure the security and ownership of the collected data, smart contracts may directly send the data from the assets to the individuals that use the data for building a machine learning model. This allows for sharing of data among the assets 830.

The collected data may be stored in the blockchain 810 based on a consensus mechanism. The consensus mechanism pulls in (permissioned nodes) to ensure that the recorded data is verified and accurate. The data recorded is time-stamped, cryptographically signed, and immutable. It is therefore auditable, transparent, and secure. Adding IoT devices that write directly to the blockchain can, in some instances (i.e., supply chain, healthcare, logistics, etc.), increase the frequency and accuracy of the recorded data.

Furthermore, training the machine learning model on the collected data may take rounds of refinement and testing by the host platform 820. Each round may be based on additional data or data that was not previously considered to help expand the knowledge of the machine learning model. In 802, the different training and testing steps (and the associated data) may be stored on the blockchain 810 by the host platform 820. Each refinement of the machine learning model (e.g., changes in variables, weights, etc.) may be stored on the blockchain 810. This provides verifiable proof of how the model was trained and what data was used to train the model. Furthermore, when the host platform 820 has achieved a finely trained model, the resulting model may be stored on the blockchain 810.

After the model has been trained, it may be deployed to a live environment where it can make predictions/decisions based on the execution of the final trained machine learning model. For example, in 804, the machine learning model may be used for condition-based maintenance (CBM) for an asset such as an aircraft, a wind turbine, a healthcare machine, and the like. In this example, data fed back from the asset 830 may be input into the machine learning model and used to make event predictions such as failure events, error codes, and the like. Determinations made by executing the machine learning model at the host platform 820 may be stored on the blockchain 810 to provide auditable/verifiable proof. As one non-limiting example, the machine learning model may predict a future breakdown/failure to a part of the asset 830 and create an alert or a notification to replace the part. The data behind this decision may be stored by the host platform 820 on the blockchain 810. In one embodiment, the features and/or the actions described and/or depicted herein can occur on or concerning the blockchain 810.

New transactions for a blockchain can be gathered together into a new block and added to an existing hash value. This is then encrypted to create a new hash for the new block. This is added to the next list of transactions when they are encrypted, and so on. The result is a chain of blocks containing the hash values of all preceding blocks. Computers that store these blocks regularly compare their hash values to ensure they are all in agreement. Any computer that does not agree discards the records causing the problem. This approach is good for ensuring tamper-resistance of the blockchain, but it is not perfect.

One way to game this system is for a dishonest user to change the list of transactions in their favor, but in a way that leaves the hash unchanged. This can be done by brute force, in other words, by changing a record, encrypting the result, and seeing whether the hash value is the same. And if not, try again and again and again until it finds a hash that matches. The security of blockchains is based on the belief that ordinary computers can only perform this kind of brute force attack over entirely impractical time scales, such as the age of the universe. By contrast, quantum computers are much faster (1000s of times faster) and consequently pose a much greater threat.

FIG. 8B illustrates an example 850 of a quantum-secure blockchain 852, which implements quantum key distribution (QKD) to protect against a quantum computing attack. In this example, blockchain users can verify each other's identities using QKD. This sends information using quantum particles such as photons, which an eavesdropper cannot copy without destroying them. In this way, a sender and a receiver can be sure of each other's identity through the blockchain.

In the example of FIG. 8B, four users are present 854, 856, 858, and 860. Each pair of users may share a secret key 862 (i.e., a QKD). Since there are four nodes in this example, six pairs of nodes exist, and therefore six different secret keys 862 are used, including QKD_{AB}, QKD_{AC}, QKD_{AD}, QKD_{BC}, QKD_{BD}, and QKD_{CD}. Each pair can create a QKD by sending information using quantum particles such as photons, which an eavesdropper cannot copy without destroying them. In this way, a pair of users can be sure of each other's identity.

The operation of the blockchain 852 is based on two procedures (i) creation of transactions and (ii) construction of blocks that aggregate the new transactions. New transactions may be created similar to a traditional blockchain network. Each transaction may contain information about a sender, a receiver, a time of creation, an amount (or value) to be transferred, a list of reference transactions that justifies the sender has funds for the operation, and the like. This transaction record is then sent to all other nodes, where it is entered into a pool of unconfirmed transactions. Here, two parties (i.e., a pair of users from 854-860) authenticate the transaction by providing their shared secret key 862 (QKD). This quantum signature can be attached to every transaction, making it difficult to tamper with. Each node checks its entries concerning a local copy of the blockchain 852 to verify that each transaction has sufficient funds. However, the transactions are not yet confirmed.

Rather than perform a traditional mining process on the blocks, the blocks may be created in a decentralized manner using a broadcast protocol. At a predetermined period (e.g., seconds, minutes, hours, etc.), the network may apply the broadcast protocol to any unconfirmed transaction to achieve a Byzantine agreement (consensus) regarding a correct version of the transaction. For example, each node may possess a private value (transaction data of that particular node). In a first round, nodes transmit their private values to each other. In subsequent rounds, nodes communicate the information they received in the previous round from other nodes. Here, honest nodes can create a complete set of transactions within a new block. This new block can be added to the blockchain 852. In one embodiment, the features and/or the actions described and/or depicted herein can occur on or concerning the blockchain 852.

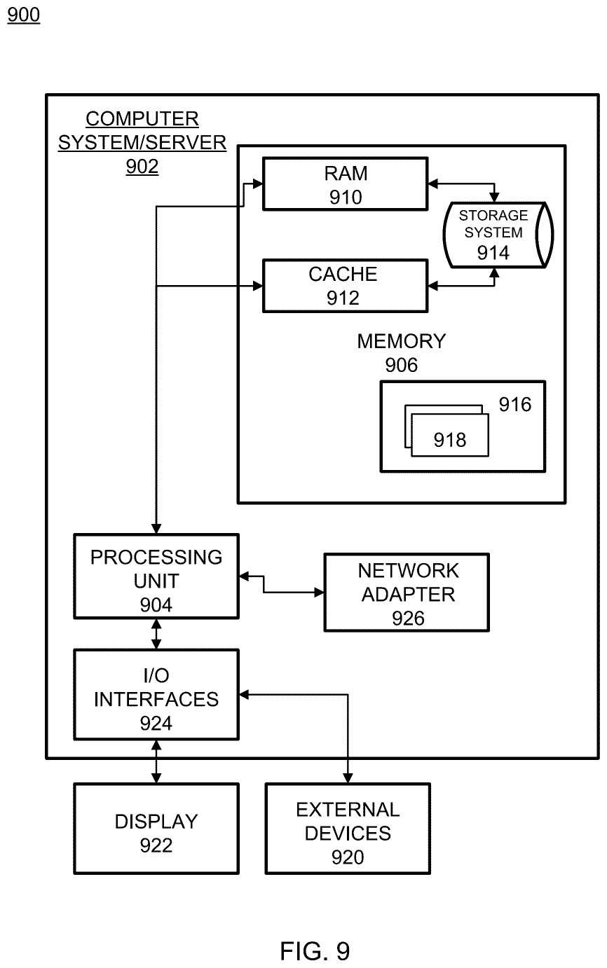

FIG. 9 illustrates an example system 900 that supports one or more of the example embodiments described and/or depicted herein. The system 900 comprises a computer system/server 902, operational with numerous general or special purpose computing system environments or configurations. Examples of well-known computing systems, environments, and/or configurations that may be suitable for use with computer system/server 902 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Computer system/server 902 may be described in the general context of computer system-executable instructions, such as program modules, executed by a computer system. Generally, program modules may include routines, programs, objects, components, logic, data structures, and perform particular tasks or implement particular abstract data types. Computer system/server 902 may be practiced in distributed cloud computing environments where tasks are performed by remote processing devices linked through a communications network. Program modules in a distributed cloud computing environment may be located in local and remote computer system storage media, including memory storage devices.

As shown in FIG. 9, computer system/server 902 in cloud computing node 900 is shown in the form of a general-purpose computing device. The components of computer system/server 902 may include, but are not limited to, one or more processors or processing units 904, a system memory 906, and a bus that couples various system components, including system memory 906 to processor 904.

The bus represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 902 typically includes various computer system readable media. Such media may be any available media accessible by computer system/server 902, and it includes both volatile and non-volatile media, removable and non-removable media. System memory 906, in one embodiment, implements the flow diagrams of the other figures. The system memory 906 can include computer system readable media in volatile memory, such as random-access memory (RAM) 910 and/or cache memory 912. Computer system/server 902 may further include other removable/non-removable, volatile/non-volatile computer system storage media. By way of example only, storage system 914 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media can be provided. Each can be connected to the bus by one or more data media interfaces in such instances. As will be further depicted and described below, memory 906 may include at least one program product having a set (e.g., at least one) of program modules configured to carry out the functions of various application embodiments.

Program/utility 916, having a set (at least one) of program modules 918, may be stored in memory 906 by way of example, and not limitation, as well as an operating system, one or more application programs, other program modules, and program data. Each of the operating systems, one or more application programs, other program modules, and program data or some combination thereof may include an implementation of a networking environment. Program modules 918 generally carry out various application embodiments' functions and/or methodologies as described herein.

As will be appreciated by one skilled in the art, aspects of the present application may be embodied as a system, method, or computer program product. Accordingly, aspects of the present application may take the form of an entire hardware embodiment, an entire software embodiment (including firmware, resident software, micro-code, etc.), or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 902 may also communicate with one or more external devices 920 such as a keyboard, a pointing device, a display 922, etc.; one or more devices that enable a user to interact with computer system/server 902; and/or any devices (e.g., network card, modem, etc.) that enable computer system/server 902 to communicate with one or more other computing devices. Such communication can occur via I/O interfaces 924. Still, yet, computer system/server 902 can communicate with one or more networks such as a local area network (LAN), a general wide area network (WAN), and/or a public network (e.g., the Internet) via network adapter 926. As depicted, network adapter 926 communicates with the other components of the computer system/server 902 via a bus. It should be understood that although not shown, other hardware and/or software components could be used in conjunction with computer system/server 902. Examples include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanying drawings and described in the foregoing detailed description, it will be understood that the application is not limited to the embodiments disclosed, but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and about various events, internal or external to the modules or components. Also, the information sent between various modules can be sent between the modules via at least one of a data network, the Internet, a voice network, an Internet Protocol network, a wireless device, a wired device, and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application but is intended to provide one example of many embodiments. Indeed, methods, systems, and apparatuses disclosed herein may be implemented in localized and distributed forms consistent with computing technology.

It should be noted that some of the system features described in this specification have been presented as modules to emphasize their implementation independence more particularly. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field-programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations, which, when joined logically together, comprise the module and achieve the stated purpose for the module. Further, modules may be stored on a computer-readable medium, such as a hard disk drive, flash device, random access memory (RAM), tape, or other medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or distributed over different locations, including over different storage devices, and may exist, at least partially, merely as electronic signals on a system or network.

It will be readily understood that the application components, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations different from those disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a memory device comprising a queue; and
a processor configured to:
receive a payment amount and an identifier of a recipient account from a digital wallet application of a user, the digital wallet application containing a payment card account and a cryptocurrency account;
determine to perform a buy-now pay-later (BNPL) transaction for the payment amount based on current holdings in the payment card account and current holdings in the cryptocurrency account;
transmit, via a crypto-bridge application programming interface (API), fiat currency from the payment card account to a crypto exchange;
receive, via the crypto-bridge API, an amount of the cryptocurrency based on the payment amount and store the amount of cryptocurrency in the digital wallet application;
generate an entry comprising a future date, the identifier of the recipient account, and a return value to retrieve from the crypto exchange at the future date; and
store the entry in the queue.

2. The apparatus of claim 1, wherein the processor is further configured to estimate a future value of the current holdings in the cryptocurrency account based on historical values of the cryptocurrency over time and a future value of the current holdings of the payment card account based on historical values of a fiat currency over time.

3. The apparatus of claim 1, wherein the processor is configured to determine to perform the BNPL transaction in response to a predicted future value of the cryptocurrency in comparison to a predicted future value of the fiat currency.

4. The apparatus of claim 1, wherein the crypto-bridge API establishes a communication channel and a message format for communication between a send money service of the digital wallet application and the crypto exchange.

5. The apparatus of claim 1, wherein the processor is configured to detect an occurrence of the future date and retrieve fiat currency from the crypto exchange via the crypto-bridge API based on a transfer of the cryptocurrency stored in the digital wallet application to the crypto exchange, and execute a payment transaction which transfers the fiat currency to the recipient.

6. The apparatus of claim 1, wherein the processor is configured to execute a time-to-live job that expires on the future date and store a pointer to the entry stored in the queue within the time-to-live job.

7. The apparatus of claim 1, wherein the processor is configured to generate a plurality of entries, each entry comprising a different respective future date, the identifier of the recipient account, and a partial return amount to retrieve from the crypto exchange at the future date and store the plurality of entries in the queue.

8. The apparatus of claim 7, wherein the processor is configured to retrieve a plurality of partial return amounts of the payment amount in fiat currency from the crypto exchange via the crypto-bridge API based on the plurality of entries in the queue at the plurality of different respective future dates, and transmit a plurality of payment card transactions to the recipient account with the plurality of partial return amounts based on the plurality of retrieved partial amounts.

9. A method comprising:
receiving a payment amount and an identifier of a recipient account from a digital wallet application of a user, the digital wallet application containing a payment card account and a cryptocurrency account;
determining to perform a buy-now pay-later (BNPL) transaction for the payment amount based on current holdings in the payment card account and current holdings in the cryptocurrency account;
transmitting, via a crypto-bridge application programming interface (API), fiat currency from the payment card account to a crypto exchange;
receiving, via the crypto-bridge API, an amount of the cryptocurrency based on the payment amount and store the amount of cryptocurrency in the digital wallet application;
generating an entry comprising a future date, the identifier of the recipient account, and a return value to retrieve from the crypto exchange at the future date; and
storing the entry in a queue.

10. The method of claim 9, wherein the determining comprises estimating a future value of the current holdings in the cryptocurrency account based on historical values of the cryptocurrency over time and a future value of the current holdings of the payment card account based on historical values of a fiat currency over time.

11. The method of claim 9, wherein the determining comprises determining to perform the BNPL transaction in response to a predicted future value of the cryptocurrency in comparison to a predicted future value of the fiat currency.

12. The method of claim 9, wherein the crypto-bridge API establishes a communication channel and a message format for communication between a send money service of the digital wallet application and the crypto exchange.

13. The method of claim 9, wherein the method further comprises detecting an occurrence of the future date, retrieving fiat currency from the crypto exchange via the crypto-bridge API based on a transfer of the cryptocurrency stored in the digital wallet application to the crypto exchange, and executing a payment transaction which transfers the fiat currency to the recipient.

14. The method of claim 9, wherein the generating further comprises executing a time-to-live job that expires on the future date and storing a pointer to the entry stored in the queue within the time-to-live job.

15. The method of claim 9, wherein the generating comprises generating a plurality of entries, each entry comprising a different respective future date, the identifier of the recipient account and a partial return amount to retrieve from the crypto exchange at the future date, and storing the plurality of entries in the queue.

16. The method of claim 15, wherein the method further comprises retrieving a plurality of partial return amounts of the payment amount in fiat currency from the crypto exchange via the crypto-bridge API based on the plurality of entries in the queue at the plurality of different respective future dates, and transmit a plurality of payment card transactions to the recipient account with the plurality of partial return amounts based on the plurality of retrieved partial amounts.

17. A computer-readable medium comprising instructions which when executed by a processor cause a computer to perform a method comprising:
receiving a payment amount and an identifier of a recipient account from a digital wallet application of a user, the digital wallet application containing a payment card account and a cryptocurrency account;
determining to perform a buy-now pay-later (BNPL) transaction for the payment amount based on current holdings in the payment card account and current holdings in the cryptocurrency account;
transmitting, via a crypto-bridge application programming interface (API), fiat currency from the payment card account to a crypto exchange;
receiving, via the crypto-bridge API, an amount of the cryptocurrency based on the payment amount and store the amount of cryptocurrency in the digital wallet application;
generating an entry comprising a future date, the identifier of the recipient account, and a return value to retrieve from the crypto exchange at the future date; and
storing the entry in a queue.

18. The computer-readable medium of claim 17, wherein the determining comprises predicting, via one or more machine learning models, a future value of the current holdings in the cryptocurrency account based on historical values of the cryptocurrency over time and a future value of the current holdings of the payment card account based on historical values of a fiat currency over time.

19. The computer-readable medium of claim 17, wherein the determining comprises determining to perform the BNPL transaction in response to a predicted future value of the cryptocurrency in comparison to a predicted future value of the fiat currency.

20. The computer-readable medium of claim 17, wherein the crypto-bridge API establishes a communication channel and a message format for communication between a send money service of the digital wallet application and the crypto exchange.
